(19) United States
(12) Patent Application Publication
(10) Pub. No.: US 2009/0134221 A1
(43) Pub. Date: May 28, 2009

(54) Tunnel-type digital imaging-based system for use in automated self-checkout and cashier-assisted checkout operations in retail store environments

(76) Inventors: Xiaoxun Zhu, Marlton, NJ (US); Tao Xian, Bordentown, NJ (US); Jie Ren, Suzhou (CN); John Gardner, Mullica Hill, NJ (US); Sean Kearney, Mailton, NJ (US); Timothy Good, Clementon, NJ (US); Michael Schnee, Aston, PA (US); Yong Liu, Suzhou (CN); Patrick Giordano, Glassboro, NJ (US); Liang Wang, Suzhou (CN); JiBin Liu, Suzhou (CN); Ming Zhuo, Suzhou (CN); Steven Essinger, Philadelpphia, PA (US); Konstantin Yakovlev, Moscow (RU); Anatoly Kotlarsky, Churchville, PA (US); Xi Tao, Suzhou (CN); Jun Lu, Suzhou (CN); Ka Man Au, Philadelphia, PA (US); Duane Ellis, Medford, NJ (US); C. Harry Knowles, Hanover, NH (US)

Correspondence Address: Thomas J. Perkowski, Esq., PC;Soundview Plaza, 1266 East Main Street, Stamford, CT, 06902, US

(21) Appl. No.: 12/283,439

(22) Filed: Sep. 11, 2008

Related U.S. Application Data
(63) Continuation-in-part of application No. 11/900,651, filed on Sep. 12, 2007.
Application No. 11/900,651 is a continuation-in-part of application No. 11/880,087, filed on Jul. 19, 2007.
Application No. 11/880,087 is a continuation-in-part of application No. 11/820,497, filed on Jun. 19, 2007.
Application No. 11/820,497 is a continuation-in-part of application No. 11/820,010, filed on Jun. 15, 2007.
Application No. 11/820,010 is a continuation-in-part of application No. 11/809,173, filed on May 31, 2007.
Application No. 11/809,173 is a continuation-in-part of application No. 11/809,174, filed on May 31, 2007.
Application No. 11/809,174 is a continuation-in-part of application No. 11/809,240, filed on May 31, 2007.
Application No. 11/809,240 is a continuation-in-part of application No. 11/809,238, filed on May 31, 2007.
Application No. 11/809,238 is a continuation-in-part of application No. 11/788,769, filed on Apr. 20, 2007.
Application No. 11/788,769 is a continuation-in-part of application No. PCT/US07/09763, filed on Apr. 20, 2007.
Application No. PCT/US07/09763 is a continuation-in-part of application No. 11/731,866, filed on Mar. 30, 2007.
Application No. 11/731,866 is a continuation-in-part of application No. 11/731,905, filed on Mar. 30, 2007.
Application No. 11/731,905 is a continuation-in-part of application No. 11/729,959, filed on Mar. 29, 2007.
Application No. 11/729,959 is a continuation-in-part of application No. 11/729,525, filed on Mar. 29, 2007.
Application No. 11/729,525 is a continuation-in-part of application No. 11/729,945, filed on Mar. 29, 2007.
Application No. 11/729,945 is a continuation-in-part of application No. 11/729,659, filed on Mar. 29, 2007.
Application No. 11/729,659 is a continuation-in-part of application No. 11/729,954, filed on Mar. 29, 2007.
Application No. 11/729,954 is a continuation-in-part of application No. 11/810,437, filed on Mar. 29, 2007.
Application No. 11/810,437 is a continuation-in-part of application No. 11/713,535, filed on Mar. 2, 2007.
Application No. 11/713,535 is a continuation-in-part of application No. 11/811,652, filed on Mar. 2, 2007.
Application No. 11/811,652 is a continuation-in-part of application No. 11/713,785, filed on Mar. 2, 2007.
Application No. 11/713,785 is a continuation-in-part of application No. 11/712,588, filed on Feb. 28, 2007.
Application No. 11/712,588 is a continuation-in-part of application No. 11/712,605, filed on Feb. 28, 2007.
Application No. 11/712,605 is a continuation-in-part of application No. 11/711,869, filed on Feb. 27, 2007.
Application No. 11/711,869 is a continuation-in-part of application No. 11/711,870, filed on Feb. 27, 2007.
Application No. 11/711,870 is a continuation-in-part of application No. 11/711,859, filed on Feb. 27, 2007.
Application No. 11/711,859 is a continuation-in-part of application No. 11/711,857, filed on Feb. 27, 2007.
Application No. 11/711,857 is a continuation-in-part of application No. 11/711,906, filed on Feb. 27, 2007.
Application No. 11/711,906 is a continuation-in-part of application No. 11/711,907, filed on Feb. 27, 2007, now Pat. No. 7,516,898.
Application No. 11/711,907 is a continuation-in-part of application No. 11/711,858, filed on Feb. 27, 2007.
Application No. 11/711,858 is a continuation-in-part of application No. 11/711,871, filed on Feb. 27, 2007.
Application No. 11/711,871 is a continuation-in-part of application No. 11/640,814, filed on Dec. 18, 2006.
Application No. 11/640,814 is a continuation-in-part of application No. PCT/US06/48148, filed on Dec. 18, 2006.
Application No. PCT/US06/48148 is a continuation-in-part of application No. 11/489,259, filed on Jul. 19, 2006.
Application No. 11/489,259 is a continuation-in-part of application No. 11/408,268, filed on Apr. 20, 2006, now Pat. No. 7,464,877.
Application No. 11/408,268 is a continuation-in-part of application No. 11/305,895, filed on Dec. 16, 2005.
Application No. 11/305,895 is a continuation-in-part of application No. 10/989,220, filed on Nov. 15, 2004, now Pat. No. 7,490,774.
Application No. 10/989,220 is a continuation-in-part of application No. 10/712,787, filed on Nov. 13, 2003, now Pat. No. 7,128,266.
Application No. 10/712,787 is a continuation-in-part of application No. 10/186,320, filed on Jun. 27, 2002, now Pat. No. 7,164,810.
Application No. 10/186,320 is a continuation-in-part of application No. 10/186,268, filed on Jun. 27, 2002, now Pat. No. 7,077,319.
Application No. 10/186,268 is a continuation-in-part of application No. PCT/US04/89389, filed on Nov. 15, 2004.
Application No. PCT/US04/89389 is a continuation-in-part of application No. 09/990,585, filed on Nov. 21, 2001, now Pat. No. 7,028,899.
Application No. 09/990,585 is a continuation-in-part of application No. 09/781,665, filed on Feb. 12, 2001, now Pat. No. 6,742,707.
Application No. 09/781,665 is a continuation-in-part of application No. 09/780,027, filed on Feb. 9, 2001, now Pat. No. 6,629,641.
Application No. 09/780,027 is a continuation-in-part of application No. 09/721,885, filed on Nov. 24, 2000, now Pat. No. 6,631,842.

(51) Int. Cl. G06K 15/00; G06K 7/10

(52) U.S. Cl. 235/383; 235/462.14; 235/462.13

(57) ABSTRACT

A tunnel-type digital imaging-based system capable of generating and projecting coplanar and/or coextensive illumination and imaging planes or zones into a 3D imaging volume within a tunnel structure. The system includes a tunnel housing structure which is supported above a package conveyor in a retail environment, and employs automatic package detection, identification, profiling/dimensioning, weighing, tracking and correlating techniques during self-checkout and/or cashier-assisted operations for achieving increased levels of efficiency and productivity.

### CROSS-REFERENCE TO RELATED U.S. APPLICATIONS

This is a Continuation-in-Part (CIP) of the following Applications: U.S. patent application Ser. No. 11/900,651 filed Sep. 12, 2007; which is a CIP of: U.S. application Ser. No. 11/880,087 filed Jul. 19, 2007; International Application No. PCT/US2007/016298 filed Jul. 19, 2007; U.S. Application No. U.S. application Ser. No. 11/820,497 filed Jun. 19, 2007; U.S. application Ser. No. 11/820,010 filed Jun. 15, 2007; U.S. application Ser. No. 11/809,173 filed May 31, 2007; U.S. application Ser. No. 11/809,174 filed May 31, 2007; U.S. application Ser. No. 11/809,240 filed May 31, 2007; U.S. application Ser. No. 11/809,238 filed May 31, 2007; Ser. No. 11/788,769 filed Apr. 20, 2007; International Application No. PCT/US07/09763 filed Apr. 20, 2007; U.S. application Ser. No. 11/731,866 filed Mar. 30, 2007; U.S. application Ser. No. 11/731,905 filed Mar. 30, 2007; U.S. application Ser. No. 11/729,959 filed Mar. 29, 2007; U.S. application Ser. No. 11/729,525 filed Mar. 29, 2007; U.S. application Ser. No. 11/729,945 filed Mar. 29, 2007; U.S. application Ser. No. 11/729,659 filed Mar. 29, 2007; U.S. application Ser. No. 11/729,954 filed Mar. 29, 2007; U.S. application Ser. No. 11/810,437 filed Mar. 29, 2007; U.S. application Ser. No. 11/713,535 filed Mar. 2, 2007; U.S. application Ser. No. 11/811,652 filed Mar. 2, 2007; U.S. application Ser. No. 11/713,785 filed Mar. 2, 2007; U.S. application Ser. No. 11/712,588 filed Feb. 28, 2007; U.S. application Ser. No. 11/712,605 filed Feb. 28, 2007; U.S. application Ser. No. 11/711,869 filed Feb. 27, 2007; U.S. application Ser. No. 11/711,870 filed Feb. 27, 2007; U.S. application Ser. No. 11/711,859 filed Feb. 27, 2007; U.S. application Ser. No. 11/711,857 filed Feb. 27, 2007; U.S. application Ser. No. 11/711,906 filed Feb. 27, 2007; U.S. application Ser. No. 11/711,907 filed Feb. 27, 2007; U.S. application Ser. No. 11/711,858 filed Feb. 27, 2007; U.S. application Ser. No. 11/711,871 filed Feb. 27, 2007; U.S. application Ser. No. 11/640,814 filed Dec. 18, 2006; International Application No. PCT/US06/48148 filed Dec. 18, 2006; U.S. application Ser. No. 11/489,259 filed Jul. 19, 2006; U.S. application Ser. No. 11/408,268 filed Apr. 20, 2006; U.S. application Ser. No. 11/305,895 filed Dec. 16, 2005; U.S. application Ser. No. 10/989,220 filed Nov. 15, 2004; U.S. application Ser. No. 10/712,787 filed Nov. 13, 2003, now U.S. Pat. No. 7,128,266; U.S. application Ser. No. 10/186,320 filed Jun. 27, 2002, now U.S. Pat. No. 7,164,810; Ser. No. 10/186,268 filed Jun. 27, 2002, now U.S. Pat. No. 7,077,319; International Application No. PCT/US2004/0389389 filed Nov. 15, 2004, and published as WIPO Publication No. WO 2005/050390; U.S. application Ser. No. 09/990,585 filed Nov. 21, 2001, now U.S. Pat. No. 7,028,899 B2; U.S. application Ser. No. 09/781,665 filed Feb. 12, 2001, now U.S. Pat. No. 6,742,707; U.S. application Ser. No. 09/780,027 filed Feb. 9, 2001, now U.S. Pat. No. 6,629,641 B2; and U.S. application Ser. No. 09/721,885 filed Nov. 24, 2000, now U.S. Pat. No. 6,631,842 B1; wherein each said application is commonly owned by Assignee, Metrologic Instruments, Inc., of Blackwood, N.J., and is incorporated herein by reference as if fully set forth herein in its entirety.

### BACKGROUND OF THE INVENTION

1. Field of Invention

The present invention relates generally to digital image capturing and processing systems capable of reading bar code symbols and other graphical indicia in retail point-of-sale (POS) and other demanding environments.

2. Brief Description of the State of Knowledge in the Art

The use of bar code symbols for product and article identification is well known in the art. Presently, various types of bar code symbol scanners have been developed for reading bar code symbols at retail points of sale (POS). In general, these bar code symbol readers can be classified into two (2) distinct classes.

The first class of bar code symbol reader uses a focused light beam, typically a focused laser beam, to sequentially scan the bars and spaces of a bar code symbol to be read. This type of bar code symbol scanner is commonly called a “flying spot” scanner as the focused laser beam appears as “a spot of light that flies” across the bar code symbol being read. In general, laser bar code symbol scanners are sub-classified further by the type of mechanism used to focus and scan the laser beam across bar code symbols.

The second class of bar code symbol readers simultaneously illuminate all of the bars and spaces of a bar code symbol with light of a specific wavelength(s) in order to capture an image thereof for recognition and decoding purposes.

The majority of laser scanners in the first class employ lenses and moving (i.e. rotating or oscillating) mirrors and/or other optical elements in order to focus and scan laser beams across bar code symbols during code symbol reading operations. Examples of hand-held laser scanning bar code readers are described in U.S. Pat. Nos. 7,007,849 and 7,028,904, each incorporated herein by reference in its entirety. Examples of laser scanning presentation bar code readers are described in U.S. Pat. No. 5,557,093, incorporated herein by reference in its entirety. Other examples of bar code symbol readers using multiple laser scanning mechanisms are described in U.S. Pat. No. 5,019,714, incorporated herein by reference in its entirety.

In demanding retail environments, such as supermarkets and high-volume department stores, where high checkout throughput is critical to achieving store profitability and customer satisfaction, it is common for laser scanning bar code reading systems to have both bottom and side-scanning windows to enable highly aggressive scanner performance. In such systems, the cashier need only drag a bar coded product past these scanning windows for the bar code thereon to be automatically read with minimal assistance of the cashier or checkout personal. Such dual scanning window systems are typically referred to as “bioptical” laser scanning systems as such systems employ two sets of optics disposed behind the bottom and side-scanning windows thereof. Examples of polygon-based bioptical laser scanning systems are disclosed in U.S. Pat. Nos. 4,229,588; 4,652,732 and 6,814,292; each incorporated herein by reference in its entirety.

Commercial examples of bioptical laser scanners include: the PSC 8500-6-sided laser based scanning by PSC Inc.; PSC 8100/8200, 5-sided laser based scanning by PSC Inc.; the NCR 7876-6-sided laser based scanning by NCR; the NCR7872, 5-sided laser based scanning by NCR; and the MS232x Stratos®H, and MS2122 Stratos® E Stratos 6 sided laser based scanning systems by Metrologic Instruments, Inc., and the MS2200 Stratos®S 5-sided laser based scanning system by Metrologic Instruments, Inc.

In general, prior art bioptical laser scanning systems are generally more aggressive than conventional single scanning window systems. However, while prior art bioptical scanning systems represent a technological advance over most single scanning window systems, in general, prior art bioptical scanning systems suffer from various shortcomings and drawbacks. In particular, the scanning coverage and performance of prior art bioptical laser scanning systems are not optimized, and require cashier-assisted operation. These systems are generally expensive to manufacture by virtue of the large number of optical components presently required to construct such laser scanning systems. Also, they require heavy and expensive motors which consume significant amounts of electrical power and generate significant amounts of heat.

In the second class of bar code symbol readers, early forms of linear imaging scanners were commonly known as CCD scanners because they used CCD image detectors to detect images of the bar code symbols being read. Examples of such scanners are disclosed in U.S. Pat. Nos. 4,282,425, and 4,570,057; each incorporated herein by reference in its entirety.

In Applicants' WIPO Publication No. WO 2005/050390, entitled “Hand-Supportable Imaging-Based Bar Code Symbol Reader Supporting Narrow-Area And Wide-Area Modes Of Illumination And Image Capture”, incorporated herein by reference, a detailed history of hand-hand imaging-based bar code symbol readers is provided, explaining that many problems that had to be overcome to make imaging-based scanners competitive against laser-scanning based bar code readers. Metrologic Instruments Focus® Hand-Held Imager is representative of an advance in the art which has overcome such historical problems. An advantage of 2D imaging-based bar code symbol readers is that they are omni-directional, by nature of image capturing and processing based decode processing software that is commercially available from various vendors.

U.S. Pat. No. 6,766,954 to Barkan et al. proposes a combination of linear image sensing arrays in a hand-held unit to form an omni-directional imaging-based bar code symbol reader. However, this hand-held imager has limited application to 1D bar code symbols, and is extremely challenged in reading 2D bar code symbologies at POS applications.

WIPO Publication No. WO 2005/050390 by Metrologic Instruments Inc., incorporated herein by reference, discloses POS-based digital imaging systems that are triggered to illuminate objects with fields of visible illumination from LED arrays upon the automatic detection of objects within the field of view of such systems using IR-based object detection techniques, and then to capture and process digital images thereof so as to read bar code symbols graphically represented in the captured images.

US Patent Publication No. 2006/0180670 to PSC Scanning, Inc. discloses digital imaging systems for use at the point of sale (POS), which are triggered to illuminate objects with visible illumination upon the detection thereof using IR-based object detection techniques.

U.S. Pat. No. 7,036,735 to Hepworth et al. disclose an imaging-based bar code reader, in which both visible (i.e. red) and invisible (i.e. IR) light emitting diodes (LEDs) are driven at different illumination intensity levels during object illumination and image capture operations so as to achieve a desired brightness in captured images, while seeking to avoid discomfort to the user of the bar code reader.

Also, US Patent Publication No. 2006/0113386 to PSC Scanning, Inc. discloses methods of illuminating bar coded objects using pulses of LED-based illumination at a rate in excess of the human flicker fusion frequency, synchronized with the exposures of a digital imager, and even at different wavelengths during sequential frame exposures of the imager. Similarly, the purpose of this approach is to be able to read bar code symbols printed on substrates having different kinds of surface reflectivity characteristics, with the added benefit of being less visible to the human eye.

However, despite the increasing popularity in area-type hand-held and presentation type imaging-based bar code symbol reading systems, and even with such proposed techniques for improved LED-based illumination of objects at POS and like imaging environments, such prior art systems still cannot complete with the performance characteristics of conventional laser scanning bi-optical bar code symbol readers at POS environments. Also, the very nature of digital imaging presents other problems which makes the use of this technique very challenging in many applications.

For example, in high-speed imaging acquisition applications, as would be the case at a retail supermarket, a short exposure time would be desired to avoid motion blurring at the POS subsystem. One known way of reducing the exposure time of the digital image detection array is to increase the intensity level of the illumination beam used to illuminate the object during illumination and imaging operations. However, at POS environments, the use of high intensity laser illumination levels is not preferred from the point of view of customers, and cashiers alike, because high brightness levels typically cause discomfort and fatigue due to the nature of the human vision system and human perception processes.

And while it is known that IR illumination can be used to form and detect digital images of bar coded labels, the use of infrared illumination degrades the image contrast quality when bar codes are printed on the thermal printing paper. Consequently, low contrast images significantly slow down imaging-based barcode decoding operations, making such operations very challenging, if not impossible, at times.

In Applicants' WIPO Publication No. WO 2002/043195, entitled “Planar Laser Illumination And Imaging (PLIIM) Systems With Integrated Despeckling Mechanisms Provided Therein”, incorporated herein by reference, Applicants address the issues of using laser illumination in diverse kinds of digital imaging barcode reading systems, including PLIIM-based digital imaging tunnel systems, namely, the inherent problem of optical noise generated by laser speckles in detected digital images. Such speckle pattern noise, as it is often called, is caused by random interferences generated by a rough paper surface, ultimately producing signal variations of the order of size of the bars and spaces of the barcode, resulting in inaccurate imaging and poor decoding. Reduction of this noise is highly desirable.

In WIPO Publication No. WO 2008/011067 entitled “Digital Image Capture And Processing Systems For Supporting 3D Imaging Volumes In Retail Point-Of-Sale Environments”, incorporated herein by reference, Applicants disclose a variety of digital image capture and processing systems and methods for generating and projecting coplanar illumination and imaging planes and/or coextensive area-type illumination and imaging zones, through one or more imaging windows, and into a 3D imaging volume in a retail POS environments. Also, Applicants disclose the use of automatic object motion and/or velocity detection, real-time image analysis and other techniques to capture and processing high-quality digital images of objects passing through the 3D imaging volume, and intelligently controlling and/or managing the use of visible and invisible forms of illumination, during object illumination and imaging operations, that might otherwise annoy or disturb human operators and/or customers working and/or shopping in such retail environments.

U.S. Pat. No. 7,161,688 to Bonner, et al. discloses a mass-transport type of image-based package identification and dimensioning system that provides dimensioning information about, and machine readable codes (i.e. identification information) from, packages passing along a conveyor belt, across a data capture point that is either singulated or non-singulated. As disclosed, the resulting data can be used to determine, for example, package dimensions, package coordinates, dimension confidence, package classification, and content and coordinates of the machine readable code. The dimensioning information is correlated with the machine readable code to form one record. Subsequent processes can access the record from all or part of the captured machine readable information to retrieve package dimension information.

Also, U.S. Pat. No. 6,330,973 to Bridgelall, et al. discloses a tunnel scanner employing a plurality of imaging or scanning modules pointed in various directions toward a target volume, seeking to increase the likelihood that a code symbol on an arbitrarily oriented object in the target volume will be read.

However, while prior digital imaging-based tunnel systems are known in the art, it has not been known how they might be designed to meet the particular needs of retail store environments, while enabling high-throughput, minimizing illumination striking the eyes of cashiers, store employees and customers, providing a relatively small form factor to meet the spatial requirements of POS environments, and support retail self-checkout and cashier-assisted checkout operations, and the like.

Thus, there is a great need in the art for improved retail-oriented digital imaging-based tunnel systems that are capable of competing with conventional laser scanning bar code readers and high-speed POS-based imaging systems employed in demanding POS environments, and of providing the many advantages offered by imaging-based bar code symbol readers, while avoiding the shortcomings and drawbacks of such prior art systems and methodologies.

### OBJECTS AND SUMMARY OF THE PRESENT INVENTION

Accordingly, a primary object of the present invention is to provide an improved digital image capturing and processing apparatus for use in POS environments, which are free of the shortcomings and drawbacks of prior art laser scanning and digital imaging systems and methodologies.

Another object of the present invention is to provide such a digital image capturing and processing apparatus in the form of an omni-directional tunnel-type digital imaging-based system that employs advanced coplanar illumination and imaging, and package identification, dimensioning and weighing technologies, to support automated self-checkout and cashier-assisted checkout operations in demanding retail store environments.

Another object of the present invention is to provide such a tunnel-type digital imaging-based system, comprising a plurality of coplanar illumination and imaging subsystems (i.e. subsystems), generating a plurality of coplanar light illumination beams and field of views (FOVs), that are projected through and intersect above an imaging window to generate a complex of linear-imaging planes within a 3D imaging volume for omni-directional imaging of objects passed therethrough.

Another object of the present invention is to provide such a tunnel-type digital imaging-based system in the form of a tunnel-type digital imaging-based system for use in retail point-of-sale environments, having omni-directional 3D imaging capabilities for automatically identifying objects such as consumer products, during self-checkout and cashier-assisted checkout operations.

Another object of the present invention is to provide such a tunnel-type digital imaging-based system, wherein each said coplanar illumination and imaging subsystem (i.e. subsystem), employing comprises a linear digital imaging engine, having independent near and far field of view (FOV) light collection optics focused onto separate segmented regions of a linear image sensing array, so as to improve the field of view and depth of field of each coplanar illumination and imaging subsystem.

Another object of the present invention is to provide such a tunnel-type digital imaging-based system, comprising a plurality of coplanar illuminating and linear imaging modules, having dual-FOV light collection optics, arranged about and supporting a 3D imaging volume above a conveyor belt surface at a retail checkout station.

Another object of the present invention is to provide such a tunnel-type digital imaging-based system having an integrated automatic package profiling/dimensioning and weight capabilities, to accurately determine package identification, and proper purchase at self-checkout counters in retail store environments.

Another object of the present invention is to provide such a tunnel-type digital imaging-based system which is integrated with a checkout computer system having a magnet-stripe or RF-ID card reader, visual display, keyboard, printer, and cash/coin handling subsystem, in a compact housing that mounts about a conveyor belt system under the control of the self-check out system of the present invention.

Another object of the present invention is to provide a tunnel-type digital imaging-based system capable of generating and projecting coplanar illumination and imaging planes into a 3D imaging volume within a tunnel structure.

Another object of the present invention is to provide such a tunnel-type digital imaging-based system, wherein automatic package identification, profiling/dimensioning, weighing and tracking techniques are employed during self-checkout operations, to reduce checkout inaccuracies and possible theft during checkout operations.

Another object of the present invention is to provide such a tunnel-type digital imaging-based system, wherein the plurality of coplanar light illumination beams can be generated by an array of coherent or incoherent light sources.

Another object of the present invention is to provide such a tunnel-type digital imaging-based system, wherein the array of coherent light sources comprises an array of visible laser diodes (VLDs).

Another object of the present invention is to provide such a tunnel-type digital imaging-based system, wherein the array of incoherent light sources comprises an array of light emitting diodes (LEDs).

Another object of the present invention is to provide such a tunnel-type digital imaging-based system, which is capable of reading (i) bar code symbols having bar code elements (i.e., ladder type bar code symbols) that are oriented substantially horizontal with respect to the imaging window, as well as (ii) bar code symbols having bar code elements (i.e., picket-fence type bar code symbols) that are oriented substantially vertical with respect to the imaging window.

Another object of the present invention is to provide such a tunnel-type digital imaging-based system, which comprises a plurality of coplanar illumination and imaging subsystems (i.e. subsystems), each of which produces a coplanar PLIB/FOV within predetermined regions of space contained within a 3-D imaging volume defined above the conveyor belt structure passing through the tunnel-type system.

Another object of the present invention is to provide such a tunnel-type digital imaging-based system, wherein each coplanar illumination and imaging subsystem comprises a planar light illumination module (PLIM) that generates a planar light illumination beam (PLIB) and a linear image sensing array and field of view (FOV) forming optics for generating a planar FOV which is coplanar with its respective PLIB.

Another object of the present invention is to provide such a tunnel-type digital imaging-based system, comprising a plurality of coplanar illumination and imaging subsystems, each employing a linear array of laser light emitting devices configured together, with a linear imaging array with substantially planar FOV forming optics, producing a substantially planar beam of laser illumination which extends in substantially the same plane as the field of view of the linear array of the subsystem, within the working distance of the 3D imaging volume.

Another object of the present invention is to provide such a tunnel-type digital imaging-based system, having an electronic weigh scale integrated with the system housing.

Another object of the present invention is to provide such a tunnel-type digital imaging-based system comprising a plurality of coplanar illumination and imaging subsystems, each employing an array of planar laser illumination modules (PLIMs).

Another object of the present invention is to provide such a tunnel-type digital imaging-based system, wherein such intelligent object presence detection, motion and trajectory detection includes the use of an imaging-based motion sensor, at each coplanar illumination and imaging subsystem, and having a field of view that is spatially aligned with at least a portion of the field of view of the linear image sensing array employed in the coplanar illumination and imaging subsystem.

Another object of the present invention is to provide such a tunnel-type digital imaging-based system, wherein the imaging-based motion sensor is used to determine the velocity of objects moving though the field of view (FOV) of a particular coplanar illumination and imaging subsystem, and automatically control the frequency at which pixel data, associated of captured linear images, is transferred out of the linear image sensing array and into buffer memory.

Another object of the present invention is to provide a tunnel-type digital imaging-based system employing a plurality of coplanar illumination and imaging subsystems, wherein each such subsystem includes a linear imaging module realized as an array of electronic image detection cells which is segmented into a first region onto which a near field of view (FOV) is focused by way of a near-type FOV optics, and a second region onto which a far field of view (FOV) is focused by way of a far-type FOV optics, to extend the field of view and depth of field of each such illumination and imaging subsystem.

Another object of the present invention is to provide such a tunnel-type digital imaging-based system employing a plurality of coplanar illumination and imaging subsystems, wherein each such subsystem includes a linear imaging module realized as an array of electronic image detection cells (e.g. CCD) having programmable integration time settings, responsive to the automatically detected velocity of an object being imaged, while moving along a conveyor belt structure, for enabling high-speed image capture operations.

Another object of the present invention is to provide a tunnel-type digital imaging-based system employing a plurality of coplanar illumination and imaging subsystems, wherein each such subsystem supports an independent image generation and processing channel that receives frames of linear (1D) images from the linear image sensing array and automatically buffers these linear images in video memory and automatically assembles these linear images to construct 2D images of the object taken along the field of view of the coplanar illumination and imaging plane associated with the subsystem, and then processes these images using exposure quality analysis algorithms, bar code decoding algorithms, and the like.

Another object of the present invention is to provide a tunnel-type digital imaging-based system capable of reading PDF and 2D bar codes on produce-eliminating keyboard entry and enjoying productivity gains.

Another object of the present invention is to provide such a tunnel-type digital imaging-based system, wherein the 2D images produced from the multiple image generation and processing channels are managed by an image processing management processor programmed to optimize image processing flows.

Another object of the present invention is to provide such a tunnel-type digital imaging-based system which supports intelligent image-based object recognition processes that can be used to automate the recognition of objects such as produce and fruit in supermarket environments.

Another object of the present invention is to provide a tunnel-type digital imaging-based system having an integrated electronic weight scale, an RFID module, and modular support of wireless technology (e.g. BlueTooth and IEEE 802.11(g)).

Another object of the present invention is to provide a tunnel-type digital imaging-based system capable of reading bar code symbologies independent of bar code orientation.

Another object of the present invention is to provide a tunnel-type digital imaging-based system having a 5 mil read capability.

Another object of the present invention is to provide a tunnel-type digital imaging-based system having an integrated Sensormatic® RFID tag deactivation device, and an integrated Checkpoint® EAS antenna, for automatically deactivating RFID tags on packages as they are transported through and exit the tunnel system.

Another object of the present invention is to provide a tunnel-type digital imaging-based system that can address the needs of the supermarket/hypermarket and grocery store market segment.

Another object of the present invention is to provide a tunnel-type digital imaging-based system having a performance advantage that leads to quicker customer checkout times and productivity gains that cannot be matched by conventional high-speed bi-optic laser scanners.

Another object of the present invention is to provide such a tunnel-type digital imaging-based system, which may also employ one or more coextensive area-type illumination and imaging subsystems, each generating an area-type illumination beam and field of view (FOV), which forms a coextensive illumination and imaging zone that is projected through and intersects above the conveyor belt structure, within a 3D imaging volume for digital imaging of objects passed therethrough.

Another object of the present invention is to provide such a POS-centric tunnel-type digital imaging-based system, which further comprises a plurality of area-type illumination and imaging subsystems, an image processing subsystem, a control subsystem, an I/O subsystem, an object recognition subsystem, a cashier's sales terminal and a customer transaction terminal.

Another object of the present invention is to provide such a POS-centric tunnel-type digital imaging-based system, having a tunnel housing architecture allowing more open and aesthetically pleasuring industrial designs required by particular retail store environments, and the like.

These and other objects of the present invention will become apparent hereinafter and in the Claims to Invention.

### BRIEF DESCRIPTION OF THE DRAWINGS

In order to more fully understand the Objects of the Present Invention, the following Detailed Description of the Illustrative Embodiments should be read in conjunction with the accompanying figure Drawings in which:

FIG. 1A is a first perspective view of a first illustrative embodiment of the tunnel-type omni-directional digital imaging system, installed about a split-type conveyor belt countertop surface provided at a self-checkout or cashier-assisted station in a retail store environment, and capable of reading bar code symbols on any of six or more sides of packages transported on its conveyor belt, and arranged in either a singulated or non-singulated manner;

FIG. 1B is a second perspective view of the omni-directional digital imaging tunnel system shown in FIG. 1A, shown with its outer housing cover and POS interface removed to reveal the more basic structure of the tunnel system architecture of the present invention;

FIG. 1C is an elevated side view of the tunnel-type omni-directional digital imaging system shown in FIG. 1B;

FIG. 1D is an elevated end view of the tunnel-type omni-directional digital imaging system shown in FIG. 1B, showing the entry port of the tunnel system;

FIG. 1E is an elevated side view of the tunnel-type omni-directional digital imaging system shown in FIG. 1B, showing the entry port of the tunnel system;

FIG. 1F is a perspective view of the tunnel-type omni-directional digital imaging system shown in FIG. 1B;

FIG. 2A is a perspective view of the tunnel-type omni-directional digital imaging system of the present invention illustrated in FIG. 1B, taken along its input side, with its checkout computer system removed from the tunnel housing, and showing (i) the input-side laser profiling/dimensioning beam disposed slightly before (i.e. upstream from) the PLIB generated from the fourth DIP and projected through the narrow gap formed between the first and second conveyor belt subsystems, and (ii) a pair of dual-FOV PLIIM-based digital linear imaging panels (DIPs) arranged on the sides of the tunnel-like housing structure, (iii) a single dual-FOV PLIIM-based digital linear imaging panel (DIP) arranged on the upper side of the tunnel-like housing structure, and (iv) an under-conveyor electronic weigh scale supported under the conveyor belt, within the tunnel housing structure;

FIG. 2B is a second perspective view of the tunnel-type digital imaging system of the present invention illustrated in FIG. 1B, taken along its output side, and showing an output-side laser profiling/dimensioning beam at its exit port;

FIG. 3A is a first perspective view of the tunnel-type digital imaging system of the present invention illustrated in FIG. 2B, shown with its outer tunnel housing structure (i.e. shell) removed to reveal, in greater detail, its side-located dual-FOV PLIIM-based DIPs, and its upper single dual-FOV PLIIM-based DIP, arranged about the conveyor belt structure, and supporting a 3D digital imaging volume above the conveyor belt within the tunnel structure;

FIG. 3B is a second perspective view of the tunnel-type digital imaging system of the present invention illustrated in FIG. 2B, shown with its outer tunnel housing structure removed to reveal, in greater detail, its side-located dual-FOV PLIIM-based DIPs, and its upper single dual-FOV PLIIM-based DIP, arranged about the conveyor belt structure, and supporting a 3D digital imaging volume above the conveyor belt within the tunnel structure;

FIG. 4A is a first perspective view of the tunnel-type digital imaging system of the present invention illustrated in FIGS. 3A and 3B, shown with its upper PLIIM-based DIP removed to reveal, in greater detail, the complex of coplanar PLIB/FOVs generated within the 3D digital imaging volume of the tunnel structure;

FIG. 4B is a second perspective view of the tunnel-type digital imaging system of the present invention illustrated in FIGS. 3A and 3B, shown with its upper PLIIM-based DIP removed to reveal, in greater detail, the complex of coplanar PLIB/FOVs within the 3D digital imaging volume generated within the center of the tunnel structure;

FIG. 5A is a first perspective view of the upper PLIIM-based DIP shown generating a coplanar PLIB/FOV from its PLIIM, and a pair of AM-laser beams at the input and output ports, from its LADAR-based detection/profiling/dimensioning subsystems integrated within the upper DIP;

FIG. 5B is a second perspective view of the upper PLIIM-based DIP shown generating a coplanar PLIB/FOV from its PLIIM, and a pair of AM-laser beams at the input and output ports, from its LADAR-based detection/profiling/dimensioning subsystems integrated within the upper DIP;

FIG. 6A1 is a perspective view showing the LADAR-based detection/profiling/dimensioning subsystems, that are integrated within the upper DIP, generating a pair of AM-laser beams at the input and output ports of the tunnel structure, for object profiling/dimensioning purposes;

FIG. 6A2 is a schematic representation of a spatial height (profile) map captured, at time instant t=T1, by each laser-based object detection/profiling/dimensioning subsystem of FIG. 6A1, disposed above the conveyor belt of the tunnel system in FIG. 2A, and illustrating that the spatial height values in the map correspond to the height profile of object(s) supported on the conveyor belt during transport through the tunnel system, and that these spatial height values can be used to compute object dimensions through real-time computation within the object detection/profiling/dimensioning subsystem, or other suitably programmed processor in the tunnel system;

FIG. 6B1 is a schematic representation of the digital tunnel system of the present invention having a triangulation-based detection/profiling/dimensioning subsystem integrated into its upper DIP, in lieu of each LADAR-based detection/profiling/dimensioning subsystem of FIG. 6A1 employed in the illustrative embodiment of FIGS. 5A through 6A, wherein the triangulation-based detection/profiling/dimensioning subsystem generates and projects a planar light illumination beam (PLIB), or a plane of structured light (generated by a laser diode or array of LEDs), and area-type imaging engine that captures digital images of objects being transported through the tunnel by the conveyor belt, while a digital image processor processes sequences of digital images in order to compute height profile and dimension information about each such object transported through the tunnel system, using the triangulation-based calculation method described in FIG. 6B2;

FIG. 6B2 is a flow chart describing the triangulation-based image processing method employed in the triangulation-based detection/profiling/dimensioning subsystem of FIG. 6B1;

FIG. 7A is a perspective partial view of the tunnel-type digital imaging system of the present invention illustrated in FIG. 2B, showing (i) the first conveyor belt subsystem mounted beneath the tunnel system and having an electronic in-motion object weighing module disposed beneath the conveyor belt for capturing spatial pressure maps of objects supported therealong while passing through the tunnel system, and (ii) the second conveyor belt subsystem supported adjacent the first conveyor belt subsystem, with a narrow gap formed between the first and second conveyor belts to allow a PLIB from a PLIIM-based digital linear imaging panel (DIP #4) arranged below the second conveyor belt subsystem, to project through the narrow gap and form and capture linear digital images of objects passing along the conveyor belt system to read code symbols disposed on the underside of packages transported along the conveyor belt;

FIG. 7B is a perspective view of the PLIIM-based digital linear imaging panel (DIP #4) arranged below the second conveyor belt subsystem, configured in the tunnel system shown in FIG. 7A;

FIG. 7C is a perspective view of the electronic in-motion object weight measuring subsystem module disposed beneath the conveyor belt of the tunnel system in FIG. 2A, for capturing spatial-pressure maps of objects supported therealong while passing through the tunnel system;

FIG. 7D is a schematic representation of a spatial pressure map captured by the electronic in-motion object weight measuring module disposed beneath the conveyor belt of the tunnel system in FIG. 2A, at time instant t=T1, illustrating that the spatial pressure values in the map correspond to the footprint of the object(s) supported on the conveyor belt during transport through the tunnel system, and that these spatial pressure values can be directly converted in object weight values through real-time computation within the in-motion object weight measuring module, or other suitably programmed processor in the tunnel system;

FIG. 8A is a perspective view of a side-located PLIIM-based DIP employing a different alternative optical path layout using a PLIB-FOV folding mirror structure within the DIP housing to fold and direct the PLIB/FOVs as shown;

FIG. 8B is a plan view of an alternative embodiment of the tunnel-type digital imaging system of the present invention employing the side-located PLIIM-based DIPs illustrated in FIG. 8A,

FIGS. 9A and 9B, taken together, set forth a block schematic representation of the tunnel-type digital imaging system of FIGS. 1A through 8B, wherein the complex of coplanar illuminating and linear imaging subsystems, constructed using either VLD or LED based illumination arrays and linear (CMOS-based) image sensing arrays, and contained within DIPs as described above, support automatic image formation and capture along each coplanar illumination and imaging plane therewithin, as well as (optional) automatic imaging-processing based object motion/velocity detection and intelligent automatic laser illumination control within the 3D imaging volume of the tunnel-type digital-imaging based system;

FIG. 10 is a block schematic representation of an illustrative embodiment of a coplanar illumination and imaging subsystem that can be employed in the tunnel systems depicted in FIG. 1A through 8B, showing its planar light illumination array (PLIA), its linear image formation and detection subsystem, its image capturing and buffering subsystem, and its local control subsystem (i.e. microcontroller) which receives object velocity data from either a conveyor belt tachometer or other data source, and generates control data for optimally controlling the planar illumination arrays and/or the clock frequency in the linear image sensing array within the coplanar image formation and detection subsystem;

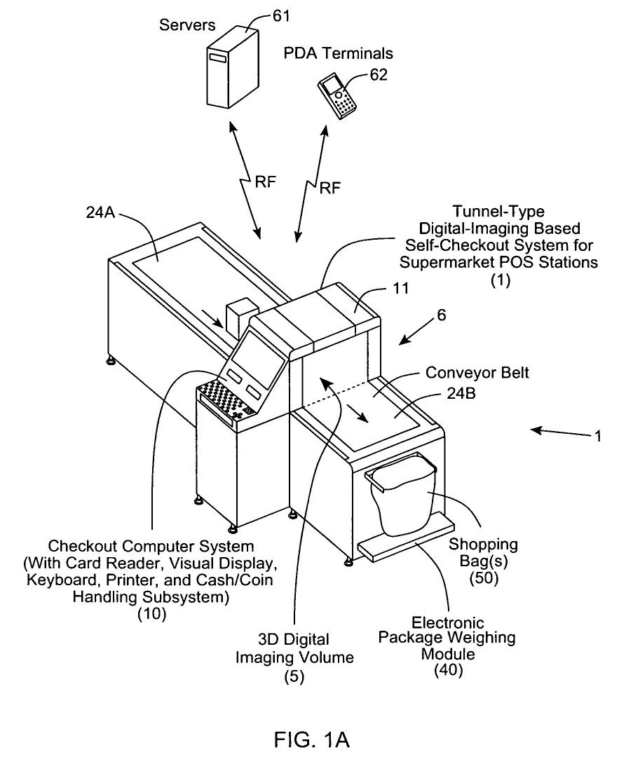

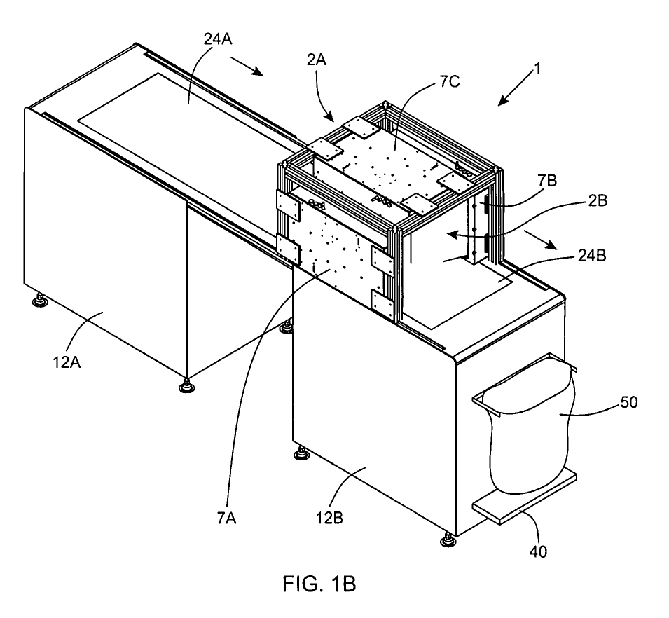

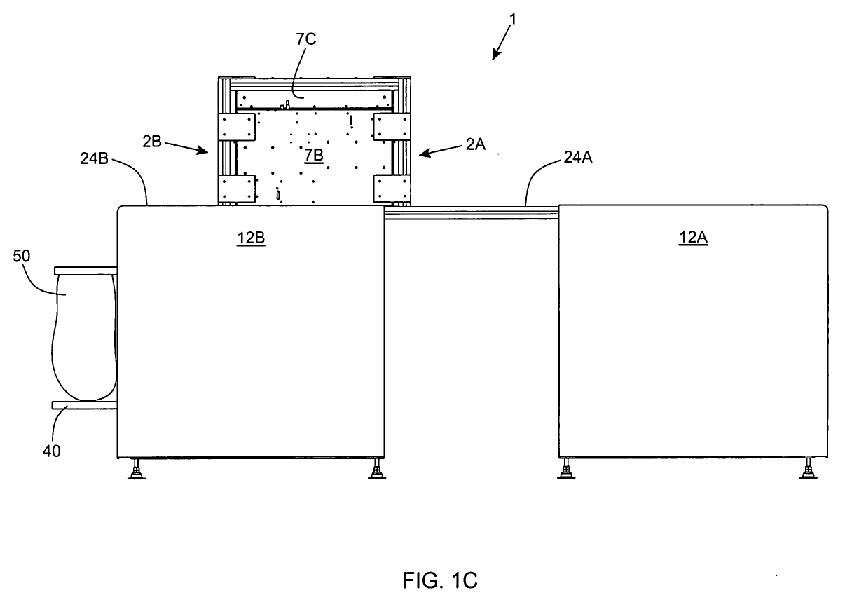

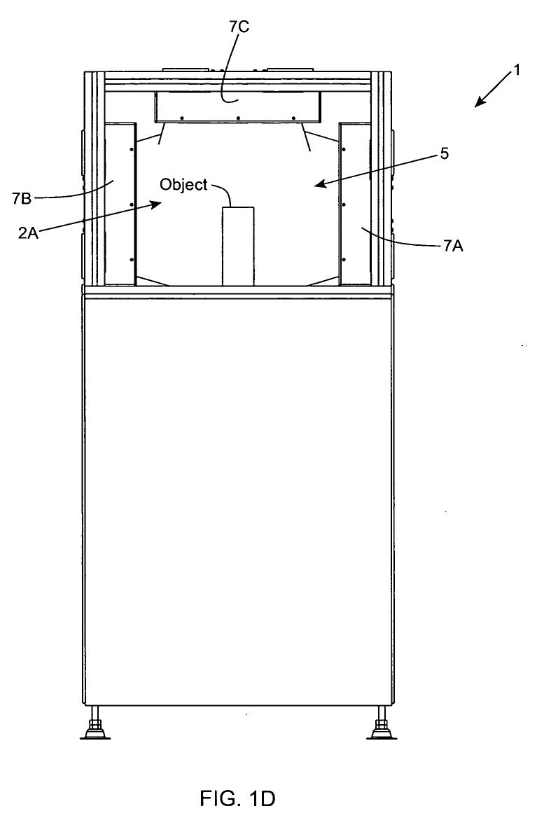

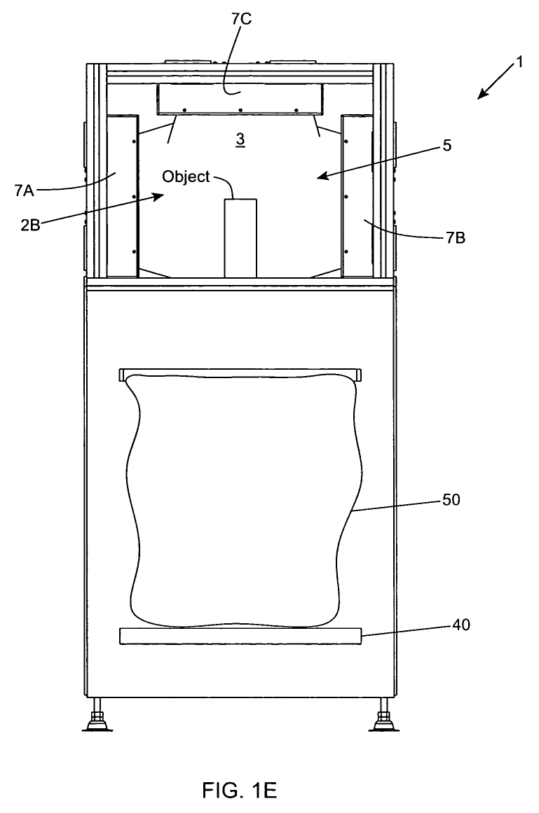

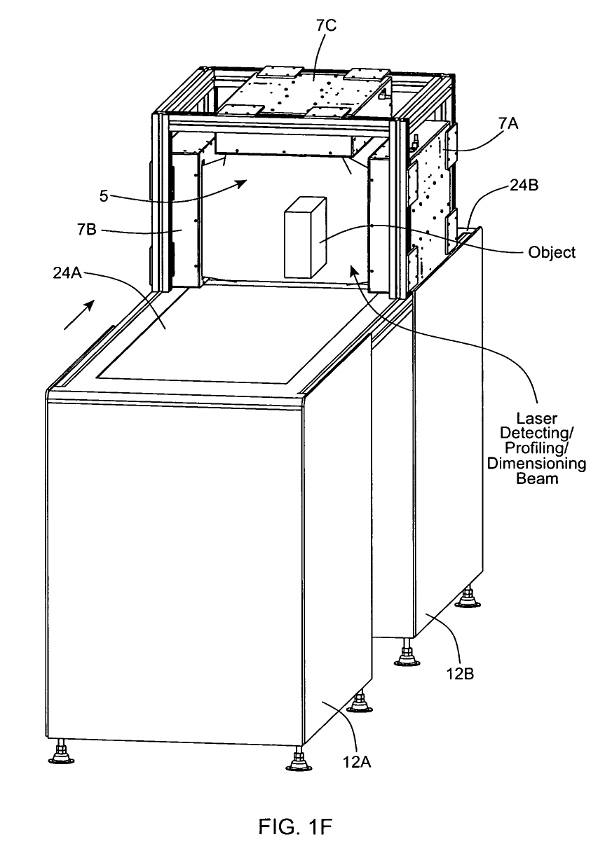

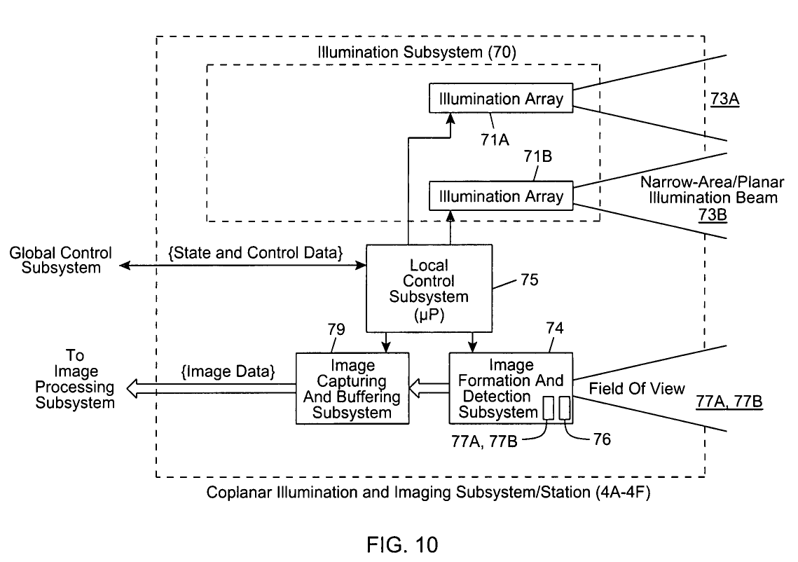

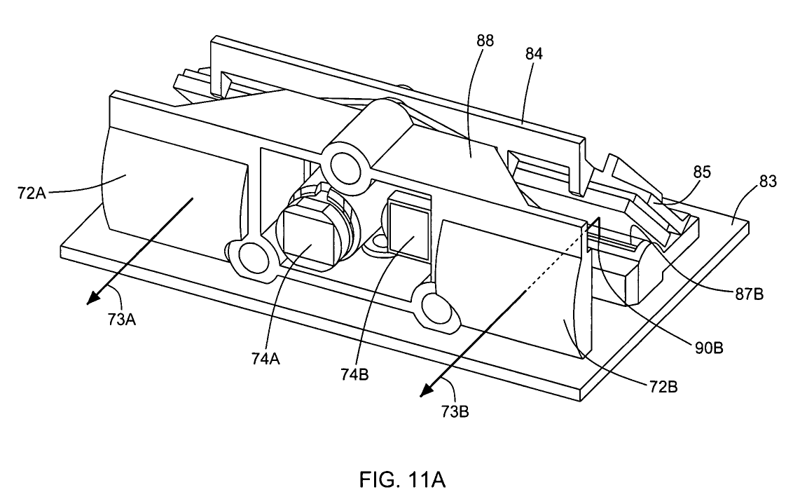

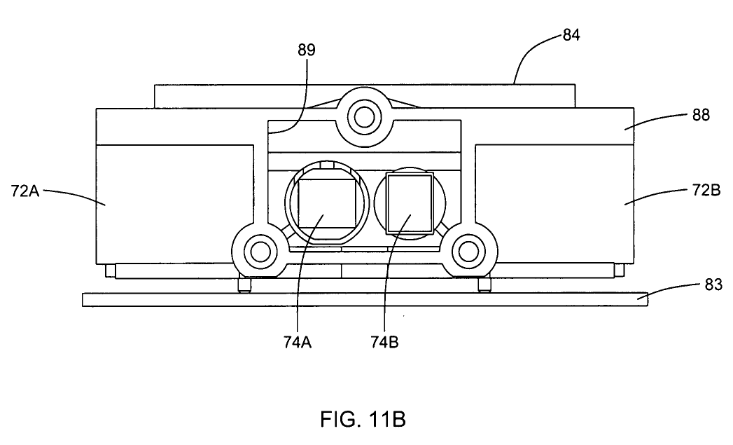

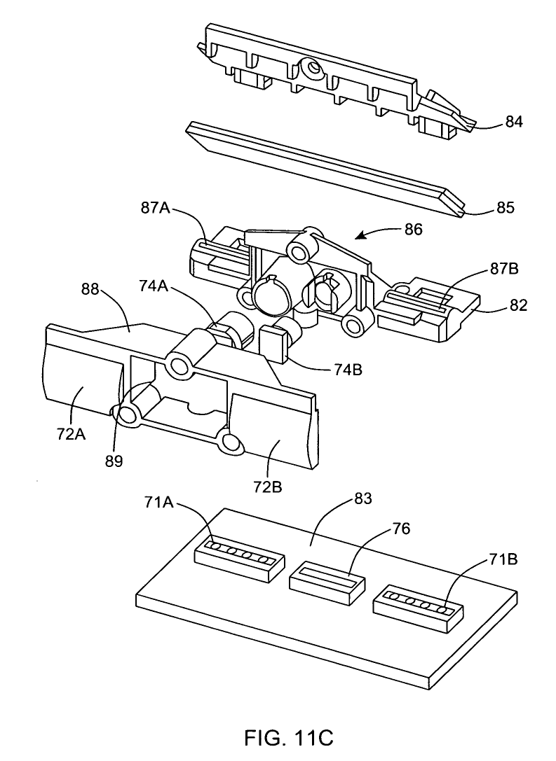

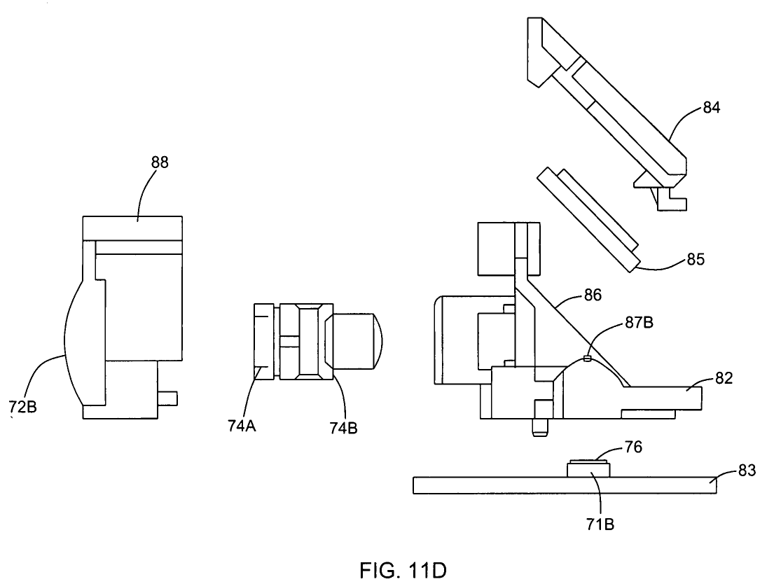

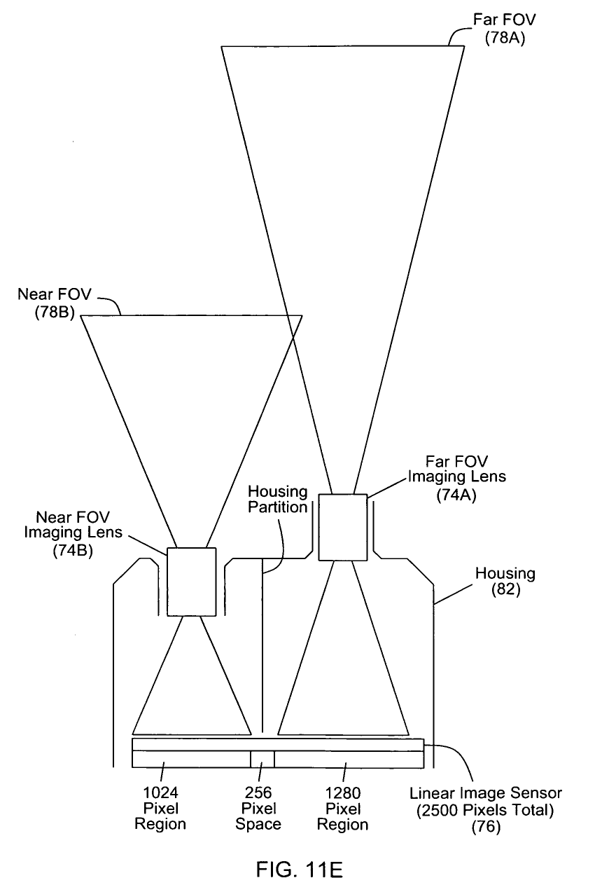

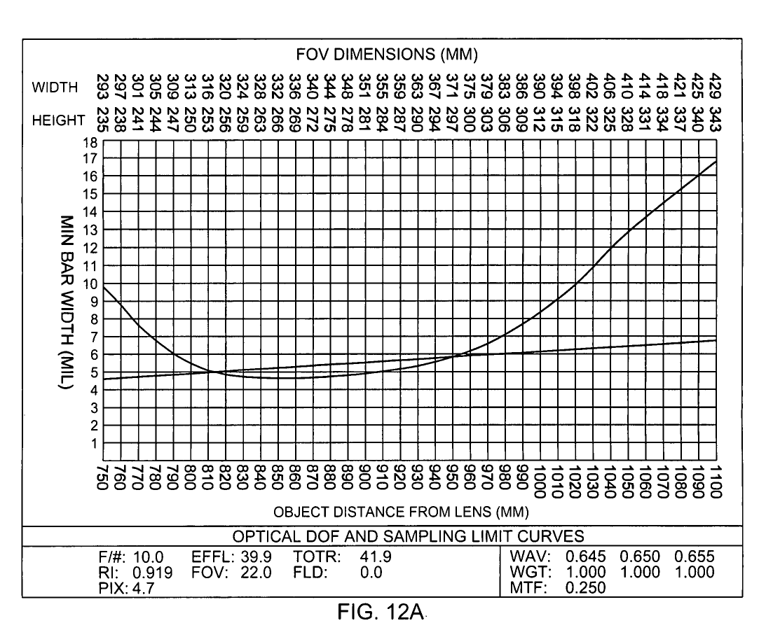

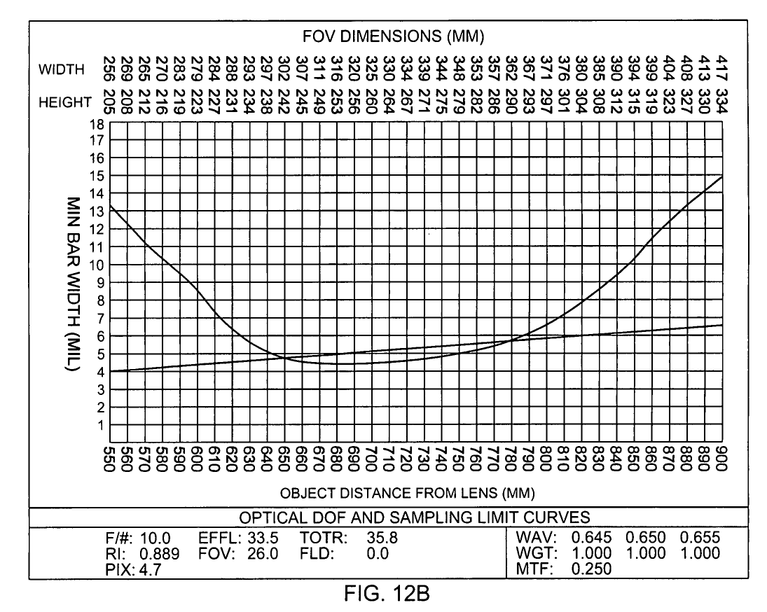

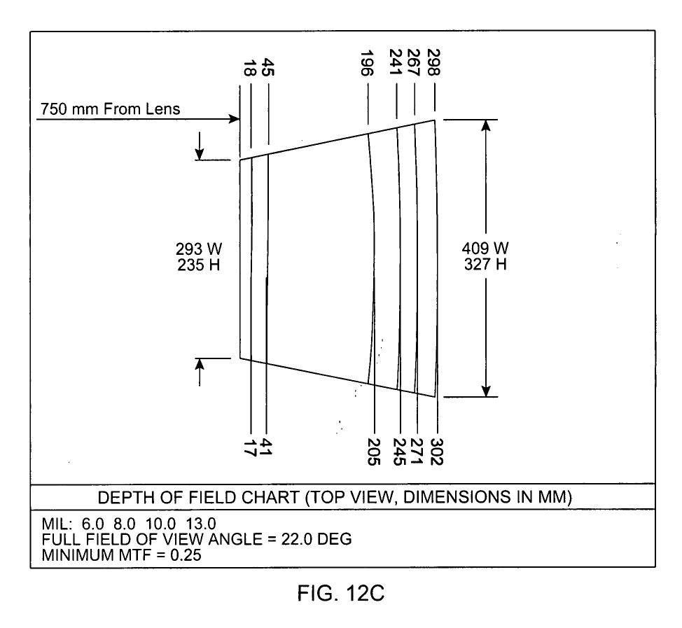

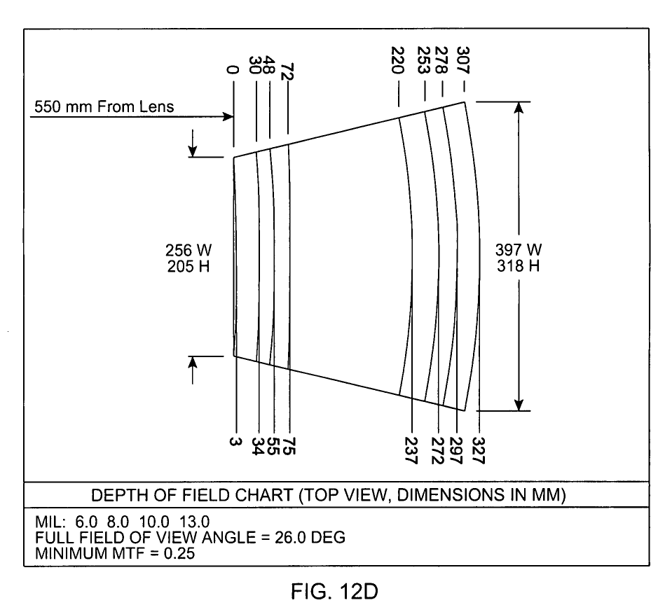

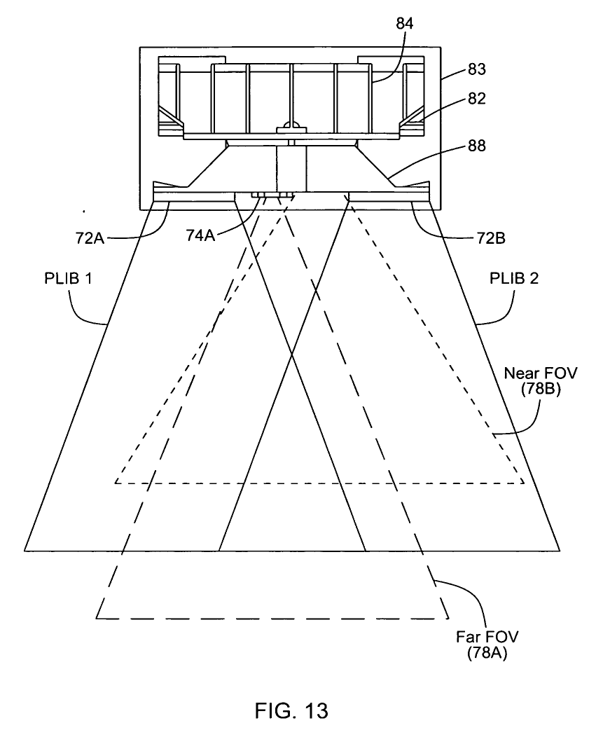

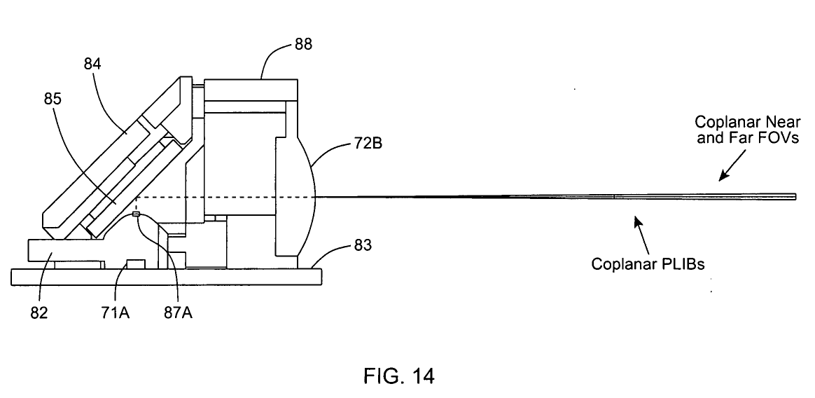

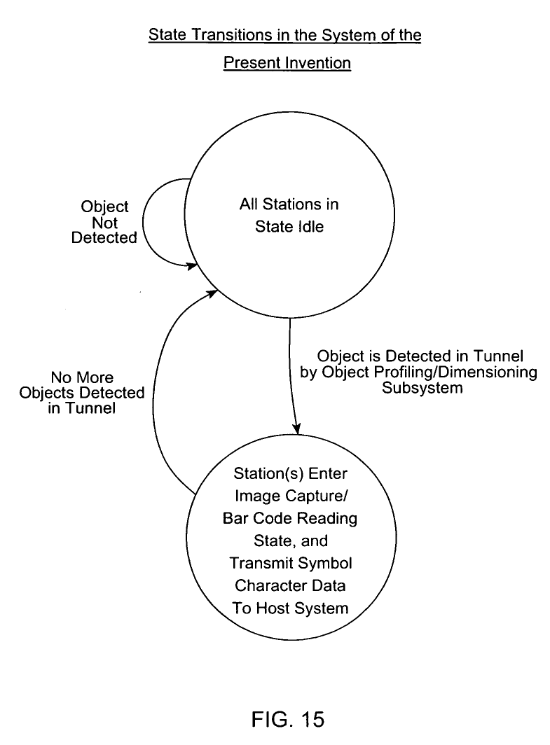

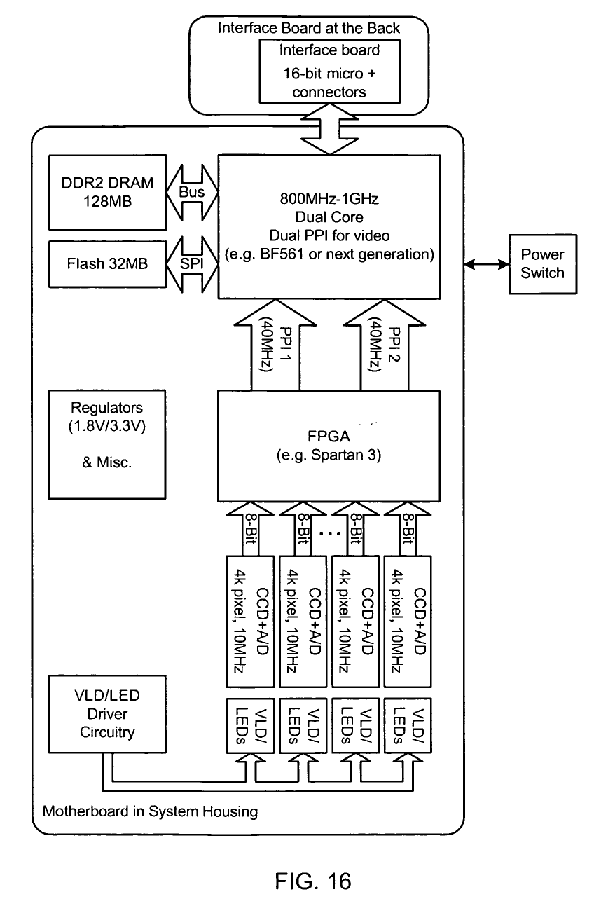

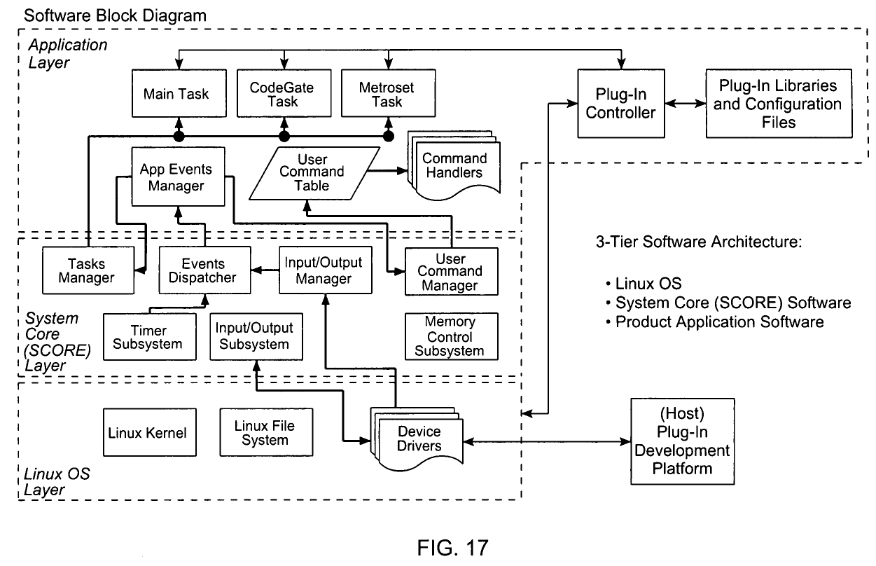

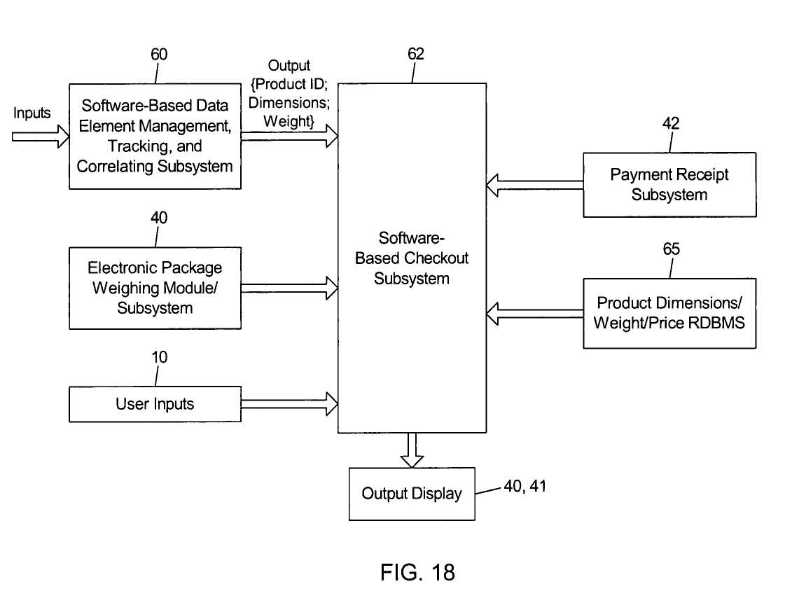

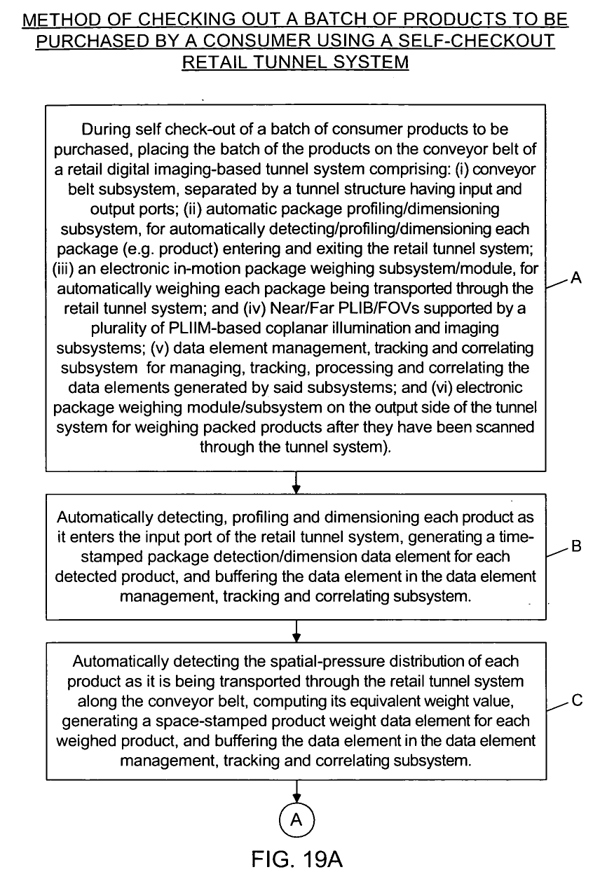

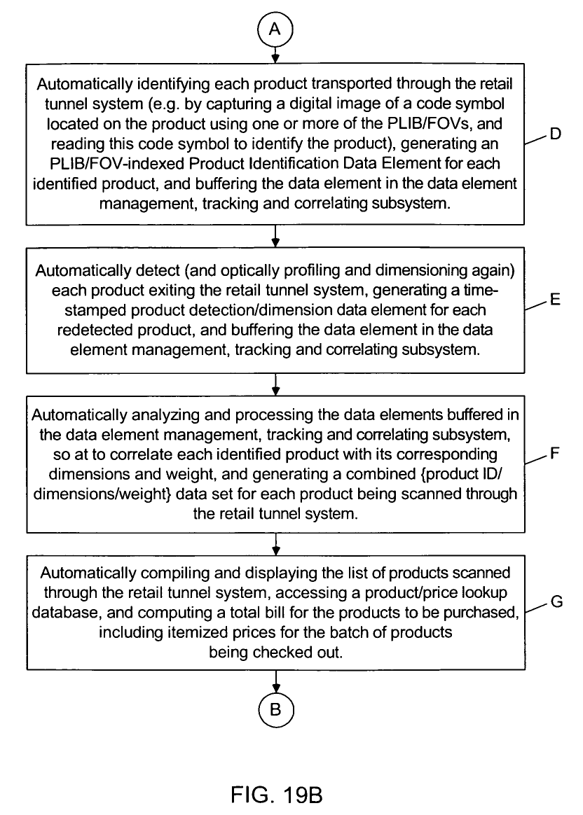

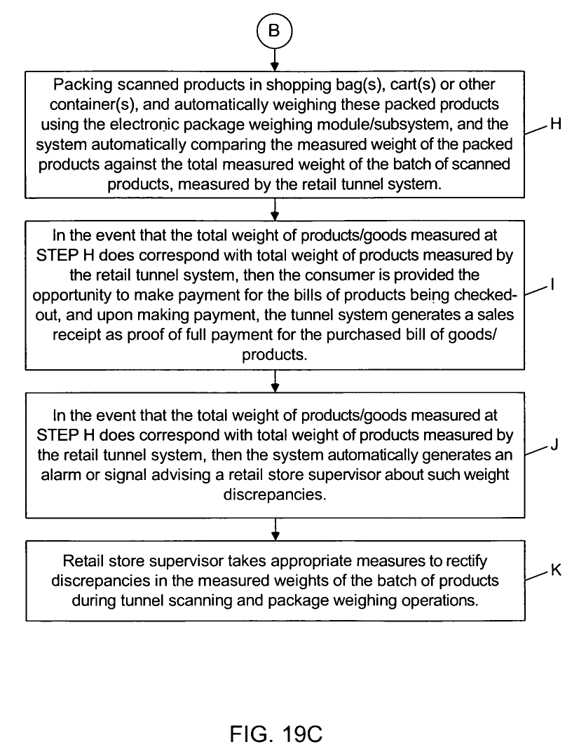

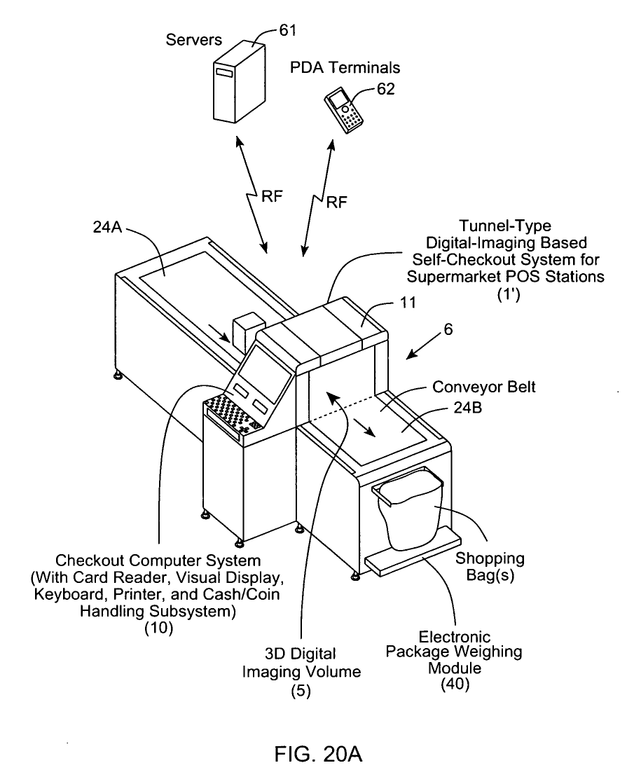

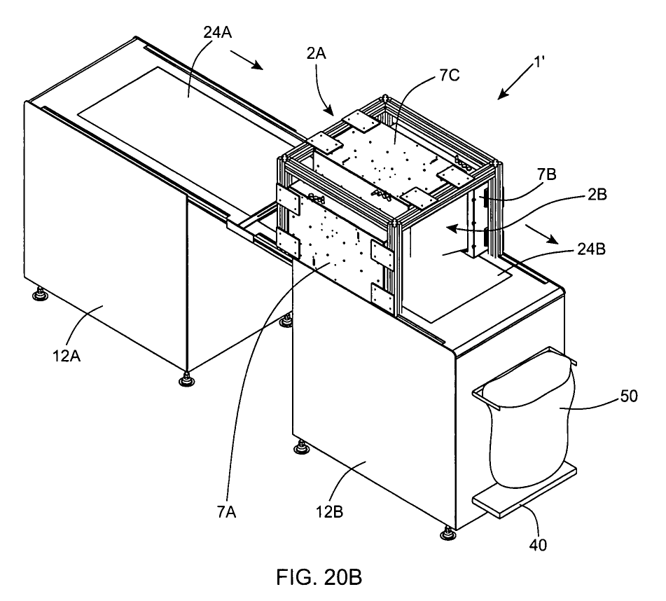

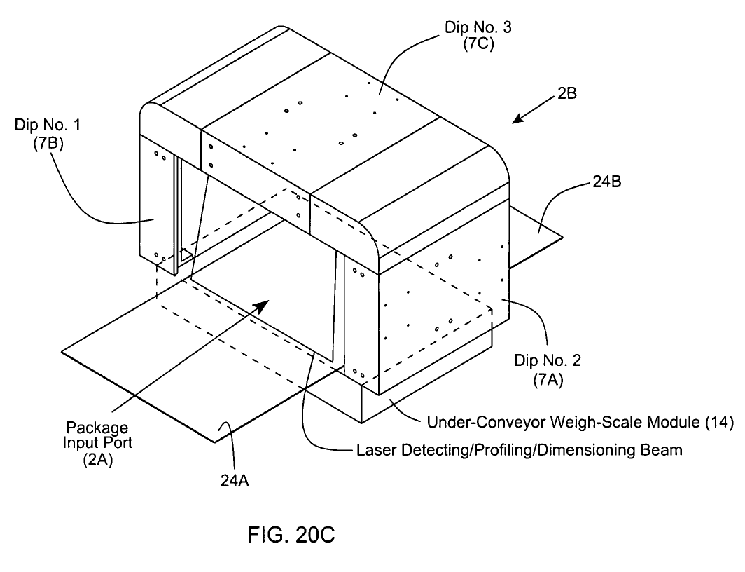

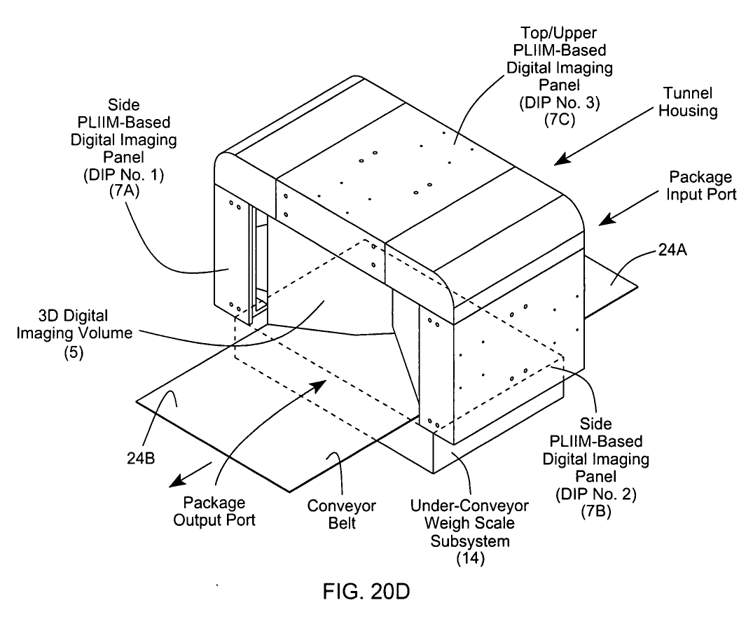

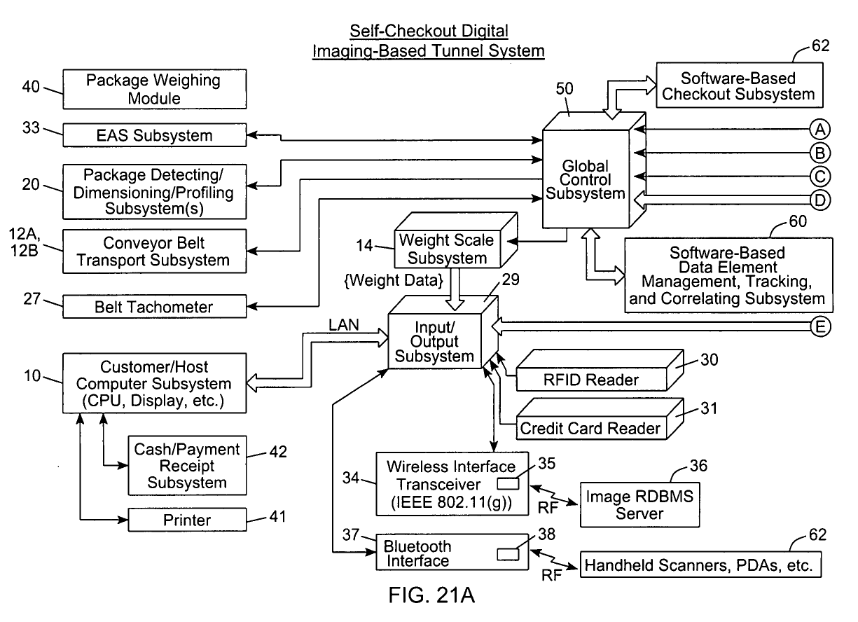

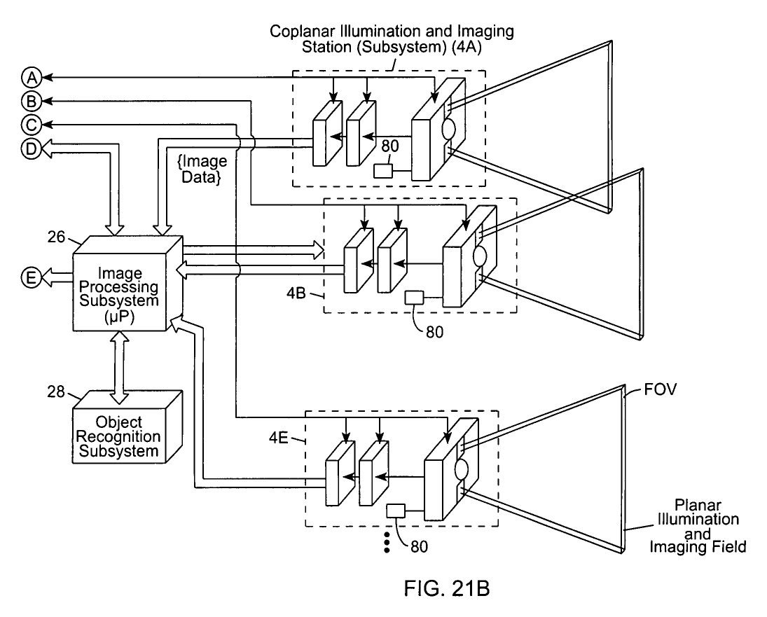

FIG. 1A is a perspective view of an illustrative embodiment of the dual field of view (dual-FOV) planar light illumination and imaging module (PLIIM) employed to implement the coplanar linear illumination and imaging subsystem schematically illustrated in FIG. 10;

FIG. 11B is an elevated front view of the dual-FOV PLIIM of FIG. 11A, showing near and far FOV optics arranged between a pair of planar light illumination beam (PLIB) forming optics;

FIG. 11C is an exploded perspective view of an illustrative embodiment of the dual-FOV PLIIM of FIGS. 11A and 11B, shown comprising (i) an optics assembly support frame supporting near and far FOV optical components in precise spatial/optical alignment to each other, and mounting on a PC board supporting a segmented linear image sensor and a pair of LED arrays, disposed on opposite sides of the linear image sensor, for producing a pair of illumination beams; (ii) a folding mirror support panel for supporting a folding mirror and attaching to the rear portion of the optics assembly support frame so as to fold the FOVs of the near and far FOV forming optics onto the first and second portions of the segmented linear image sensing array, as illustrated in FIG. 11E, as well as to fold the pair of illumination beams along the optical axis of the FOV forming optics; and (iii) a planar light illumination beam (PLIB) forming optics assembly having an imaging window and attaching to the optics assembly support frame, to shape the pair of folded illumination beams into a pair of substantially planar illumination beam (PLIBs) transmitted into the near and far FOVs of the module in a coplanar manner;

FIG. 11D is a exploded side view of an illustrative embodiment of the dual-FOV PLIIM of FIGS. 11A and 11C;

FIG. 11E is a schematic representation of the dual-FOV PLIIM of FIGS. 11A and 11B, showing only its segmented linear image sensing array and its far and new FOV forming optical components supported within a housing structure having a partition between its far and near FOV light collection chambers;

FIG. 12A are optical depth of field (DOF) and sampling limit curves for the far field of view (FOV) forming optics employed in the dual-FOV PLIIM of each coplanar linear illumination and imaging subsystem illustrated in FIGS. 10 and 11C;

FIG. 12B are optical depth of field (DOF) and sampling limit curves for the near field of view (FOV) forming optics employed in the dual-FOV PLIIM of each coplanar linear illumination and imaging subsystem illustrated in FIGS. 10 and 11C;

FIG. 12C is a depth of field (DOF) chart for the far field of view (FOV) forming optics employed in the dual-FOV PLIIM of the coplanar linear illumination and imaging subsystem illustrated in FIGS. 10 and 11C;

FIG. 12D is a depth of field (DOF) chart for the far field of view (FOV) forming optics employed in the dual-FOV PLIIM of the coplanar linear illumination and imaging subsystem illustrated in FIGS. 10 and 11C;

FIG. 13 is a plan view of the dual-FOV PLIIM employed in the coplanar illumination and imaging subsystem illustrated in FIGS. 10 and 11C, showing its pair of PLIBs projecting in a coplanar manner within the near and far field of views (FOVs) of the PLIIM, in accordance with the principles of the present invention;

FIG. 14 is an elevated side view of the dual-FOV PLIIM employed in the coplanar illumination and imaging subsystem illustrated in FIGS. 10 and 11C, showing the coplanar relationship between the PLIBs and FOVs supported by each such PLIIM;

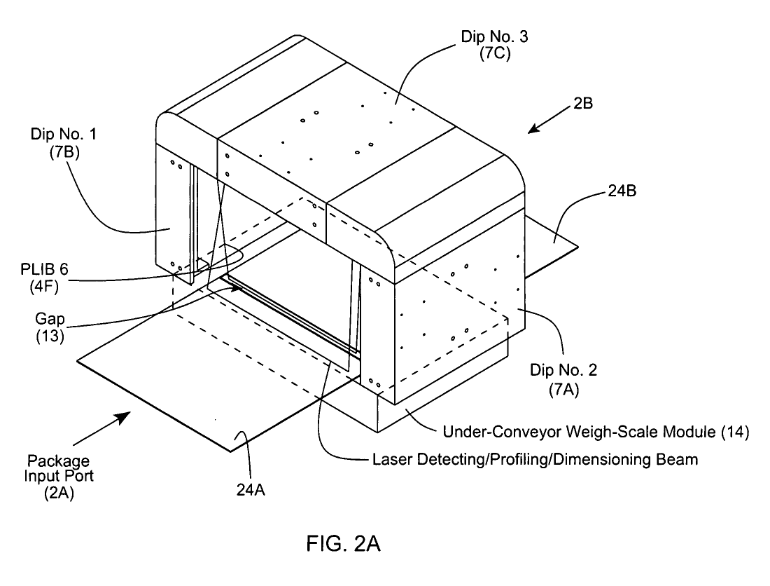

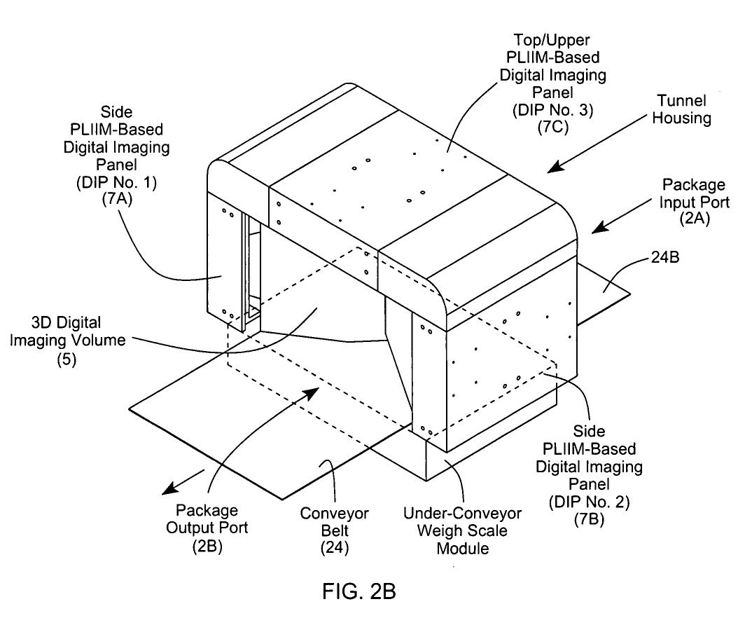

FIG. 15 is a state transition diagram for the tunnel-type digital imaging system of FIG. 2A, running its system control program, during an illustrative embodiment of the present invention;

FIG. 16 is a schematic diagram describing an exemplary embodiment of a computing and memory architecture platform for implementing the tunnel-type digital imaging system of FIG. 2A;

FIG. 17 is a schematic representation of a multi-tier software architecture that can run upon the computing and memory architecture platform of FIG. 16, so as to implement the functionalities of the tunnel-type digital imaging system of the first illustrative embodiment of the present invention;

FIG. 18 is a schematic representation of the software-based object detection, management, tracking and correlation subsystem running on the computing and memory architecture platform of FIG. 16, configured to automatically (i) manage and track, in real-time, package identification data elements (e.g UPCs) generated by each PLIIM-based coplanar illumination and imaging subsystem illustrated in FIGS. 10 and 11C, and package dimension data elements generated by the object detection/profiling/dimensioning subsystems employed in the tunnel-type system, and (ii) correlating one package dimension data element with one package identification data element, as packages are transported through the tunnel system of the present invention;

FIGS. 19A through 19C set forth a flow chart describing the high level process carried out by the software-based object detection, management, tracking and correlation subsystem of FIG. 18, as objects are transported through the tunnel-type digital imaging system of the present invention;

FIG. 20A is a first perspective view of a second illustrative embodiment of the tunnel-type omni-directional digital imaging system, installed about a split-type conveyor belt countertop surface provided at a self-checkout, or cashier-assisted station in a retail store environment, and capable of reading bar code symbols on any of five sides of packages transported on its conveyor belt, and arranged in either a singulated or non-singulated manner;

FIG. 20B is a second perspective view of the omni-directional digital imaging tunnel system shown in FIG. 20A, shown with its outer housing cover and POS interface removed to reveal the more basic structure of the tunnel system architecture of the present invention;

FIG. 20C is a perspective view of the tunnel-type omni-directional digital imaging system of the present invention illustrated in FIG. 20B, taken along its input side, with its checkout computer system removed from the tunnel housing, and showing (i) the input-side laser profiling/dimensioning beam; (ii) a pair of dual-FOV PLIIM-based digital linear imaging panels (DIPs) arranged on the sides of the tunnel-like housing structure; (iii) a single dual-FOV PLIIM-based digital linear imaging panel (DIP) arranged on the upper side of the tunnel-like housing structure; and (iv) an under-conveyor electronic weigh scale supported under the conveyor belt within the tunnel housing structure;

FIG. 20D is second perspective view of the tunnel-type digital imaging system of the present invention illustrated in FIG. 1B, taken along its output side, and showing an output-side laser profiling/dimensioning beam at its exit port; and

FIGS. 21A and 21B, taken together, set forth a block schematic representation of the tunnel-type digital imaging system of FIGS. 20A through 20D, wherein the complex of coplanar illuminating and linear imaging subsystems, constructed using either VLD or LED based illumination arrays and linear (CMOS-based) image sensing arrays, and contained within DIPs as described above, support automatic image formation and capture along each coplanar illumination and imaging plane therewithin.

### DETAILED DESCRIPTION OF THE ILLUSTRATIVE EMBODIMENTS OF THE PRESENT INVENTION

Referring to the figures in the accompanying Drawings, the various illustrative embodiments of the illumination and imaging apparatus and the methodologies of the present invention will be described in greater detail, wherein like elements will be indicated using like reference numerals.

### Overview of the Digital Imaging Tunnel-Type System of the Present Invention

In the illustrative embodiments, the illumination and imaging apparatus of the present invention is realized in the form of an advanced, omni-directional tunnel-type digital image capturing and processing system 1 that can be deployed in various application environments, including but not limited to retail point of sale (POS) subsystems 1, as shown in FIGS. 1A and 20A. In the illustrative embodiments of the present invention, the system 1 will include either a closed or partially open tunnel-like arrangement with package/object input and output ports 2A, 2B, through which a conveyor belt transport structure 24A, 24B passes, and within which a complex of coplanar illumination and imaging planes 3 are (i) automatically generated from a complex of coplanar illumination and imaging subsystems (i.e. modules) 4A through 4F mounted about the conveyor belt structure 24, and (ii) projected within a 3D imaging volume 5 defined above the conveyor belt within the spatial confines of the tunnel-like arrangement.

In general, the complex of coplanar illumination and imaging subsystems 4A through 4F are arranged about the conveyor belt structure subsystem 24B in the tunnel system to capture digital linear (1D) or narrow-area images along the field of view (FOV) of its coplanar illumination and imaging planes, using laser or LED-based illumination, depending on the tunnel system design and implementation. These captured digital images are then buffered and decode-processed using linear (1D) type image capturing and processing based bar code reading algorithms, or can be assembled together to reconstruct 2D images for decode-processing using 1D/2D image processing based bar code reading techniques, as taught in Applicants' U.S. Pat. No. 7,028,899 B2, incorporated herein by reference.

Referring to FIG. 1A, the illustrative embodiment of the tunnel-type omni-directional digital imaging self-checkout system of the present invention is shown installed about a conveyor belt countertop surface at a self-checkout subsystem 6 in a retail store environment, such as a supermarket or superstore. As shown, the tunnel system 1 comprises a tunnel-like housing structure with side and top sections, providing input and output ports 2A and 2B for the transport of packages (e.g. products) and other objects being checked out at a self-checkout or cashier-assisted station 10 interfaced with the tunnel system.

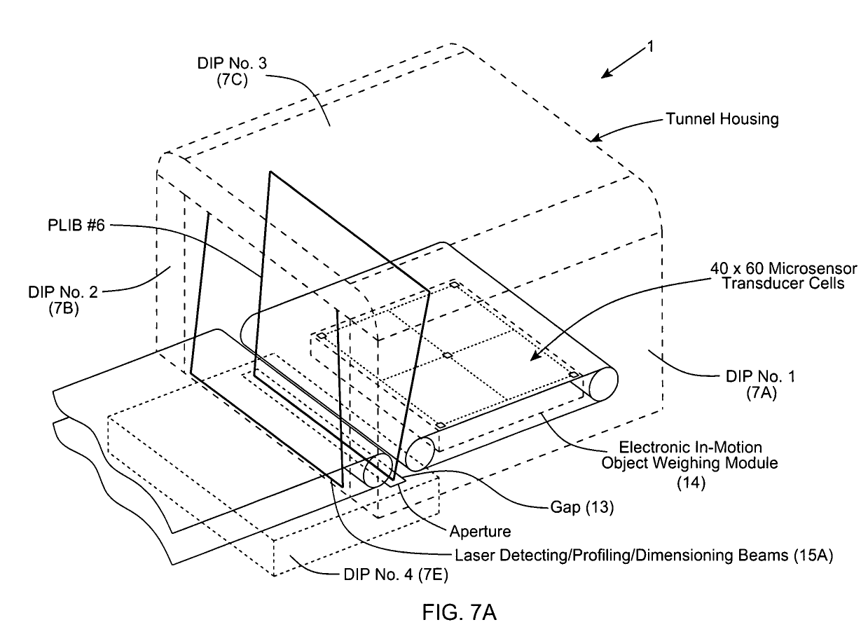

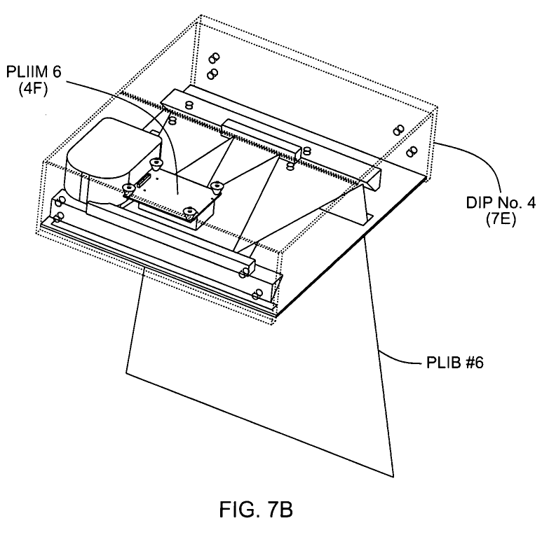

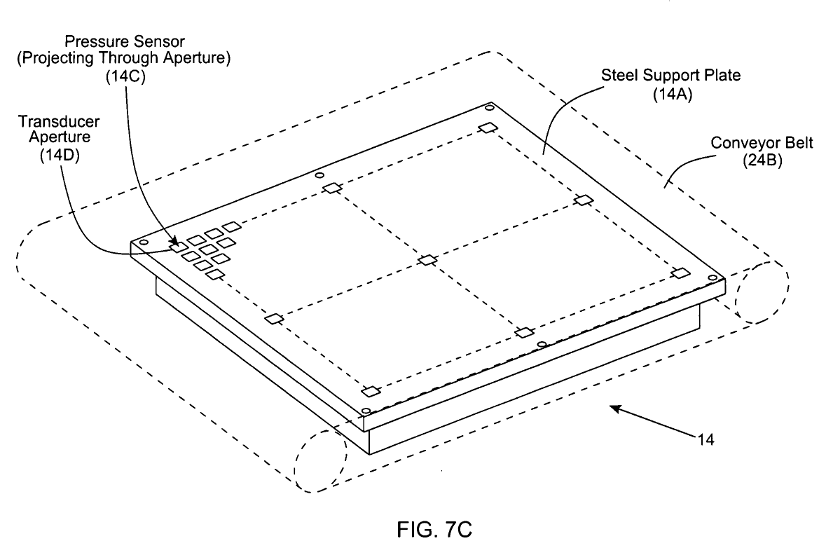

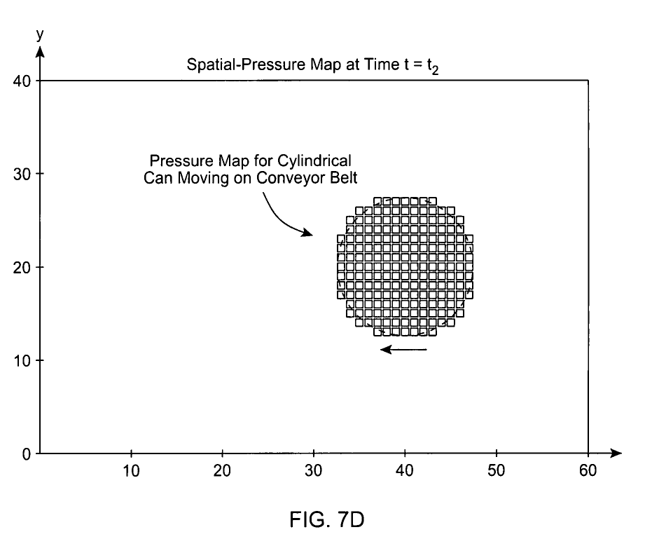

FIGS. 1B through 1F show the tunnel system from different views, with its outer housing cover 11 removed to reveal the underlying construction of the tunnel system of the illustrative embodiment. As shown, the tunnel system includes a conveyor belt system comprising a first conveyor belt subsystem 12A disposed beneath the tunnel structure, and a second conveyor belt subsystem 12B, spaced closely to the first conveyor belt subsystem 24A so that a small narrow gap 13 is formed along the conveyor belt surface, within the input port of the tunnel structure, as best shown in FIGS. 2A and 7A.

FIG. 1B shows the tunnel-type digital imaging system of the present invention with its self-checkout computer system or cashier-assisted station 10 removed from the tunnel housing. As shown, the tunnel system comprises: (i) a pair of dual-FOV PLIIM-based digital linear imaging panels (DIPs) 7A and 7B arranged on opposite sides of the tunnel-like housing structure, and the conveyor belt structure of the first conveyor belt subsystem; (ii) one single dual-FOV PLIIM-based digital linear imaging panel (DIP) 7C arranged on the upper side of the tunnel-like housing structure, which can be made from plastic, metal or composite material; (iii) one single dual-FOV PLIIM-based digital linear imaging panel (DIP) 7D arranged below the second conveyor belt subsystem so that its coplanar PLIB/FOV projects through the gap region 13 and can capture linear digital images of code symbols on the underside of objects being transported through the tunnel system; and (iv) an under-conveyor electronic weighing subsystem 14 supported under the conveyor belt 12B, within the tunnel housing structure 9.

As shown in FIG. 2A, the third DIP located above the conveyor belt generates and projects a first object detection/profiling/dimensioning beam 15A towards the conveyor belt surface and disposed slightly before (i.e. upstream from) the PLIB #5, that is generated by the fourth DIP 7D, beneath the second conveyor subsystem 12B and projected through the narrow gap 13 formed between the first and second conveyor belt subsystems. This allows the tunnel system to automatically detect, profile and dimension objects prior to identifying them within the tunnel system.

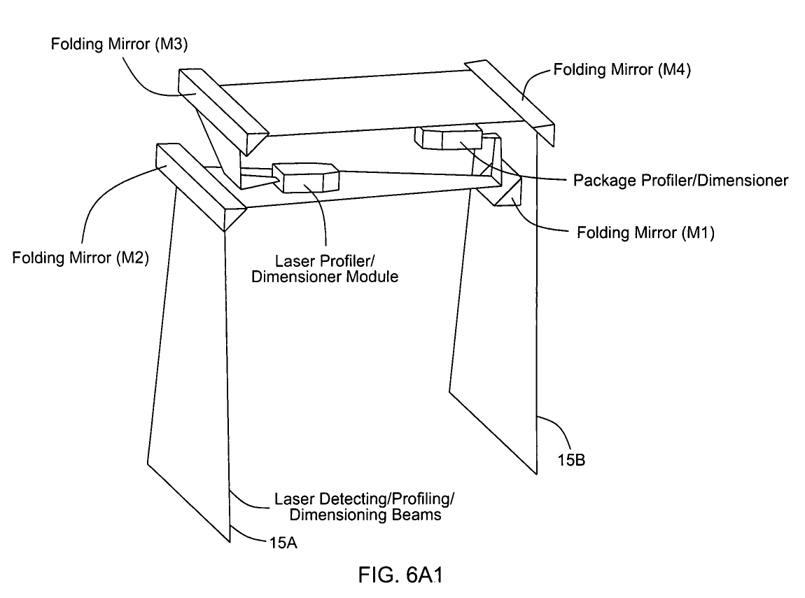

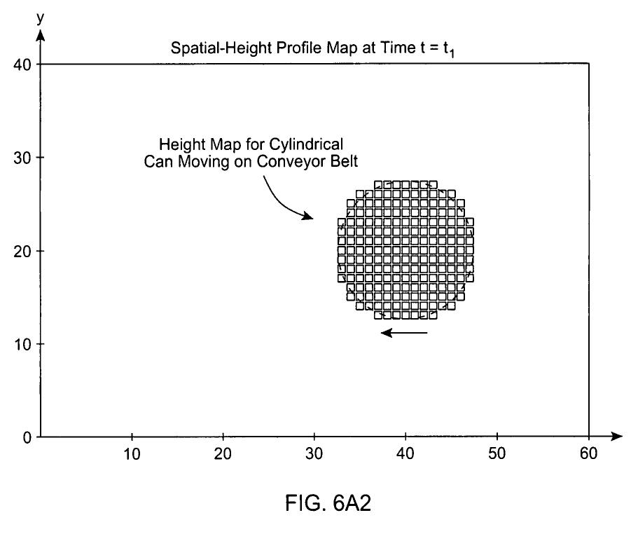

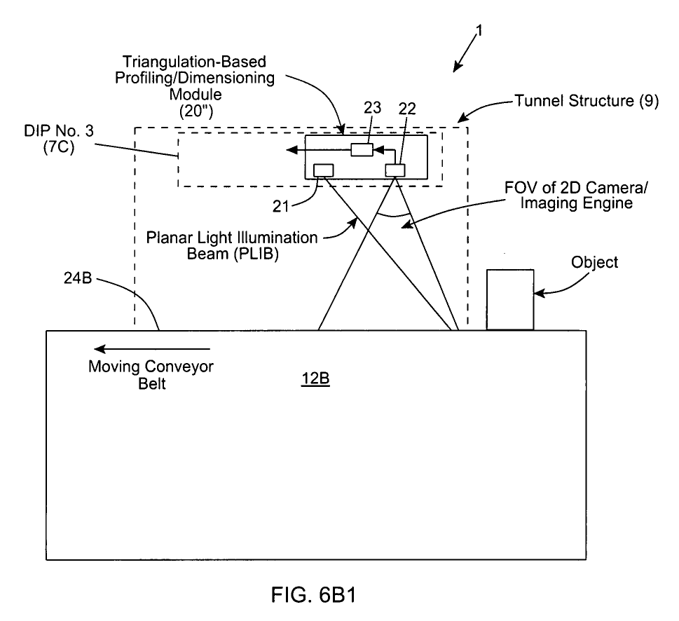

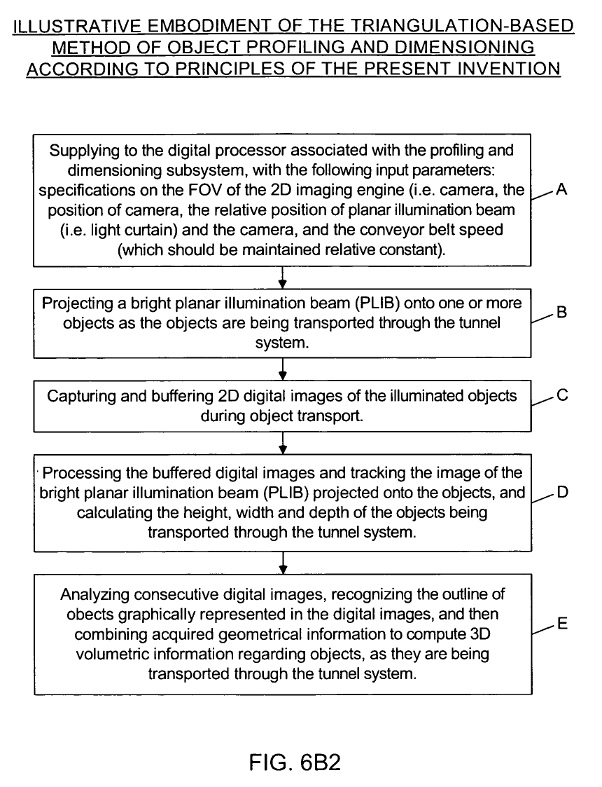

As shown in FIG. 2B, the third DIP 7C located above the conveyor belt also generates and projects a second object detection/profiling/dimensioning beam 15B towards the conveyor belt surface at the exit port of the tunnel system. This allows the tunnel system to automatically redetect objects as they exit the tunnel system, providing additional information about the state of profiled, identified and tracked objects passing through the system, which can be used in the data element management and tracking architecture illustrated in FIG. 18. As will be described in greater detail hereinafter, these first and second object detection/profiling/dimensioning beams can be implemented differently, as indicated in the LADAR-based subsystem of FIGS. 6A1 and 6A2, and the triangulation-based subsystem of FIGS. 6B1 and 6B2. In each different embodiment of this subsystem, object detection, profile and dimensional information are captured, but the principles of operation of each object detection/profiling/dimensioning beam are different, as will be specified in greater technical detail hereinafter.

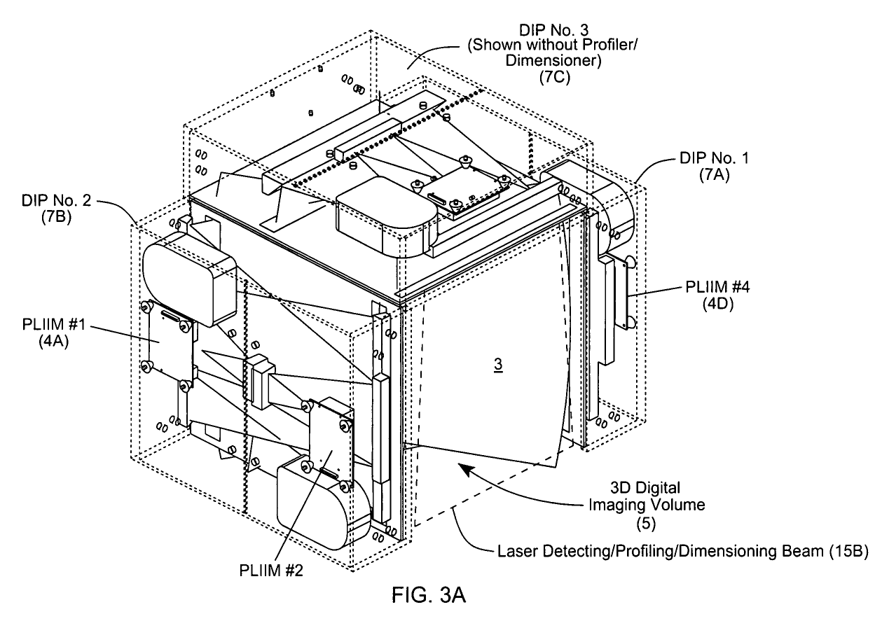

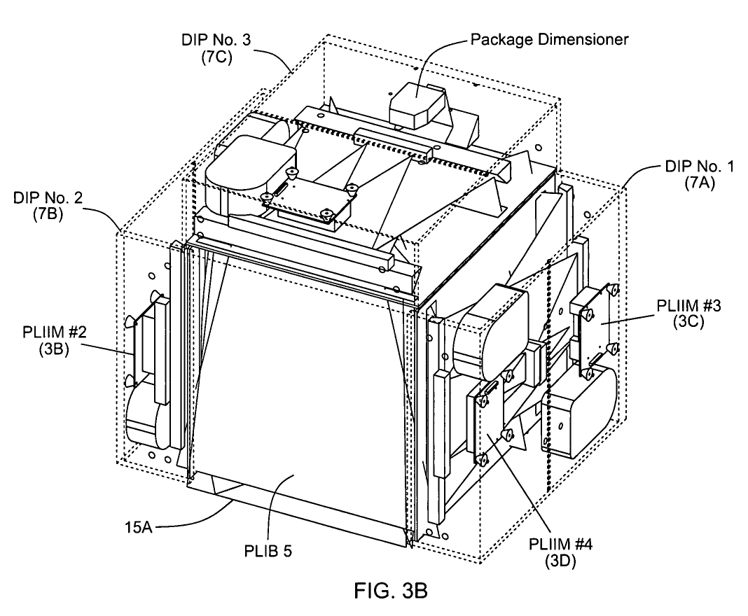

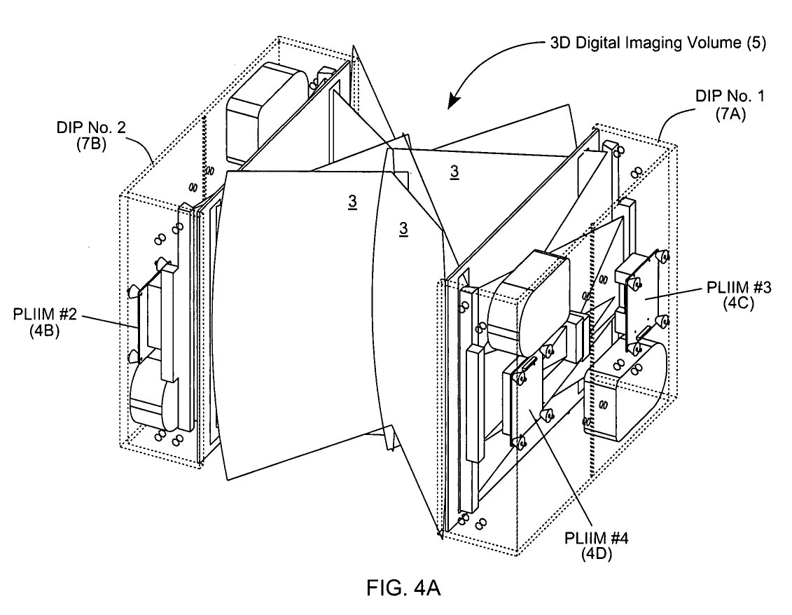

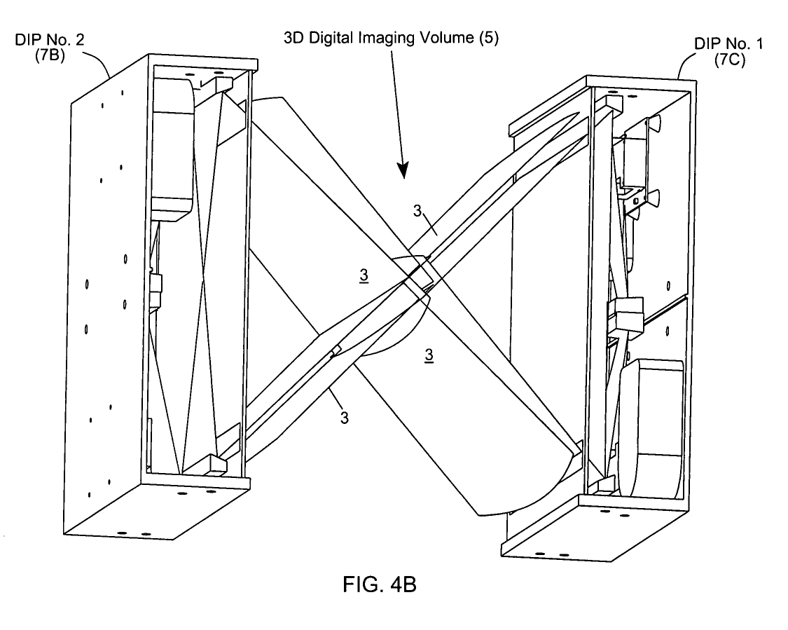

As shown in FIGS. 3A and 3B, each side-located PLIIM-based DIP 7A and 7B employs a pair of dual-FOV PLIIMs 4A, 4B, and 4C, 4D, which generate a pair of coplanar PLIB/FOVs that intersect within the 3D imaging volume of the tunnel system, as illustrated in FIGS. 4A and 4B, and generate a complex of coplanar PLIB/FOVs within the 3D digital imaging volume generated within the center of the tunnel structure.

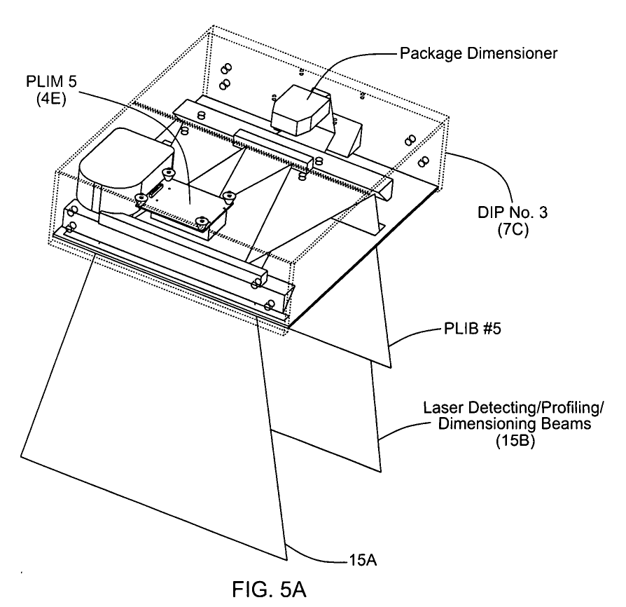

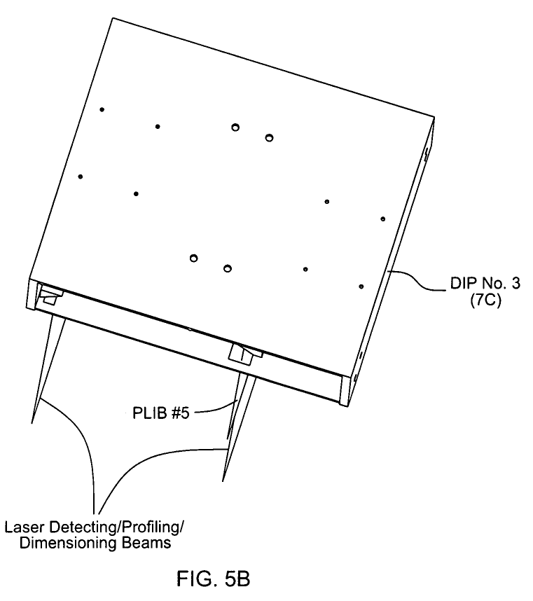

As shown in FIGS. 5A and 5B, the upper PLIIM-based DIP, arranged above the conveyor belt structure, automatically generates and projects a coplanar PLIB/FOV #5 downwardly towards the conveyor surface, which captures digital linear images of objects. These digital images are then processed in an effort to read bar code symbols and other graphical indicia on the top surfaces of objects as they are transported through the tunnel system. As indicated in FIGS. 5A and 5B, the coplanar PLIB/FOV is arranged, at the input port, slightly behind the first laser profiling/dimensioning beam employed in the upper DIP, allowing for automatic identification of objects immediately after they are detected and profiled/dimensioned.

The object detection/profiling/dimensioning subsystem in the upper DIP can be implemented in a variety of different ways.

In FIGS. 6A1 and 6A2, the object detection/profiling/dimensioning beam is an AM-laser beam functioning in a LADAR-based package profiling and dimensioning subsystem shown and described in International Publication No. WO 02/43195 A2, incorporated herein by reference in its entirety. In this embodiment, the LADAR-based detection/profiling/dimensioning subsystems 20′ are integrated within the upper DIP, and generating a pair of AM-laser beams at the input and output ports of the tunnel structure, for object profiling/dimensioning purposes. As indicated in FIG. 6A2, these subsystem automatically generate a spatial height (profile) map captured, at time instant t=T1. Notably, these spatial height values correspond to the height profile of object(s) supported on the conveyor belt during transport through the tunnel system, and are used to compute object dimensions through real-time computation within the object detection/profiling/dimensioning subsystem, or other suitably programmed processor in the tunnel system.

In FIGS. 6B1 and 6B2, the object detection/profiling/dimensioning beam is a planar light illumination beam (e.g. structured light generated from one or more VLDs or LEDs) functioning in a triangulation-based package profiling/dimensioning subsystem. As indicated in FIG. 6B1, a triangulation-based detection/profiling/dimensioning subsystem 20″ is integrated into the upper DIP 7C, in lieu of each LADAR-based detection/profiling/dimensioning subsystem of FIG. 6A1. In this illustrative embodiment, the triangulation-based detection/profiling/dimensioning subsystem comprises: (i) a planar illumination module (PLIM) 21 employing one or more VLDs or LEDs, for generating and projecting a planar light illumination beam (PLIB), i.e. a plane of structured light, towards the conveyor belt carrying one or more objects into the tunnel system, as illustrated in FIG. 6A1; (ii) area-type 2D imaging engine (i.e. camera) 22 for capturing digital 2D images of objects being transported through the tunnel by the conveyor belt; and (iii) a digital image processor 23 for processing sequences of digital images in order to compute height profile and dimension information about each such object transported through the tunnel system, using the triangulation-based calculation method described in FIG. 6B2.

As indicated in FIG. 6B2, the method employed in the triangulation-based detection/profiling/dimensioning subsystem of FIG. 6B1 comprises a number of primary steps: (a) supplying to the digital processor associated with the profiling and dimensioning subsystem, with the following input parameters: specifications on the FOV of the 2D imaging engine (i.e. camera, the position of camera, the relative position of planar illumination beam (i.e. light curtain) and the camera, and the conveyor belt speed (which should be maintained relative constant); (b) projecting a bright planar illumination beam (PLIB) onto one or more objects as the objects are being transported through the tunnel system; (c) capturing and buffering 2D digital images of the illuminated objects during object transport: (d) processing the buffered digital images and tracking the image of the bright planar illumination beam (PLIB) projected onto the objects, and calculating the height, width and depth of the objects being transported through the tunnel system; and (e) analyzing consecutive digital images, recognizing the outline of objects graphically represented in the digital images, and then combining acquired geometrical information to compute 3D volumetric information regarding objects, as they are being transported through the tunnel system.

Referring now to FIG. 7A, the conveyor belt system employed in the tunnel-type digital imaging system of the present invention of FIG. 2B, is shown in greater detail, comprising: (i) first conveyor belt subsystem 12A mounted beneath the tunnel system and having an electronic in-motion object weighing module 14 disposed beneath the conveyor belt for capturing spatial pressure maps of objects supported therealong while passing through the tunnel system; and (ii) second conveyor belt subsystem 12B supported adjacent the first conveyor belt subsystem 12A, with narrow gap 13 formed between the first and second conveyor belts 12A and 12B to allow the PLIB #6 from a PLIIM-based digital linear imaging panel (DIP #4) 7D arranged below the second conveyor belt subsystem 24A, to project through the narrow gap 13 and form and capture linear digital images of objects passing along the conveyor belt system to read code symbols disposed on the underside of packages (e.g. consumer products) transported along the conveyor belt through the tunnel system.

FIG. 7C shows in greater detail the electronic in-motion object weight measuring subsystem 14 that is disposed beneath the conveyor belt of the tunnel system in FIG. 2A. As shown, the module 14 comprises a steel support plate 14A, supporting a plurality of micro-sized piezo-electric pressure transducers 14C which pass through a plurality of apertures 14B formed in the steel support plate. The function of subsystem 14 is capturing spatial-pressure maps of objects supported therealong while passing through the tunnel system. FIG. 7D provides a schematic representation of a spatial pressure map captured by the electronic in-motion object weight measuring subsystem 14, at time instant t=T1. This schematic representation illustrates that the spatial pressure values in the map correspond to the footprint of the object(s) supported on the conveyor belt during transport through the tunnel system, and that these spatial pressure values can be directly converted into object weight values through real-time computation by an onboard digital processor supported within the in-motion object weight measuring module, or by any other suitably programmed processor provided in the tunnel system.

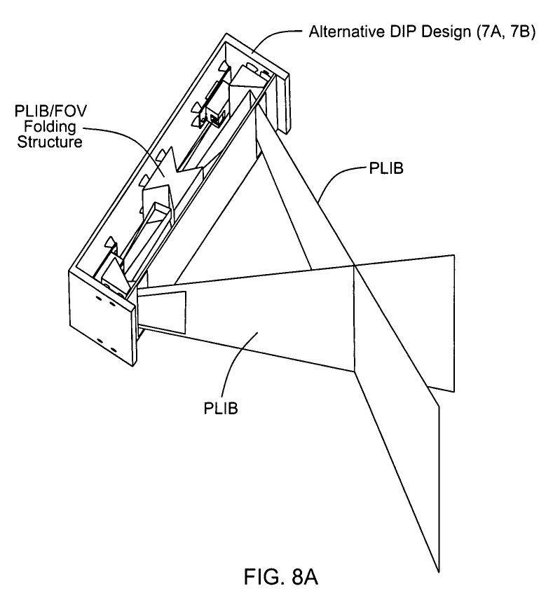

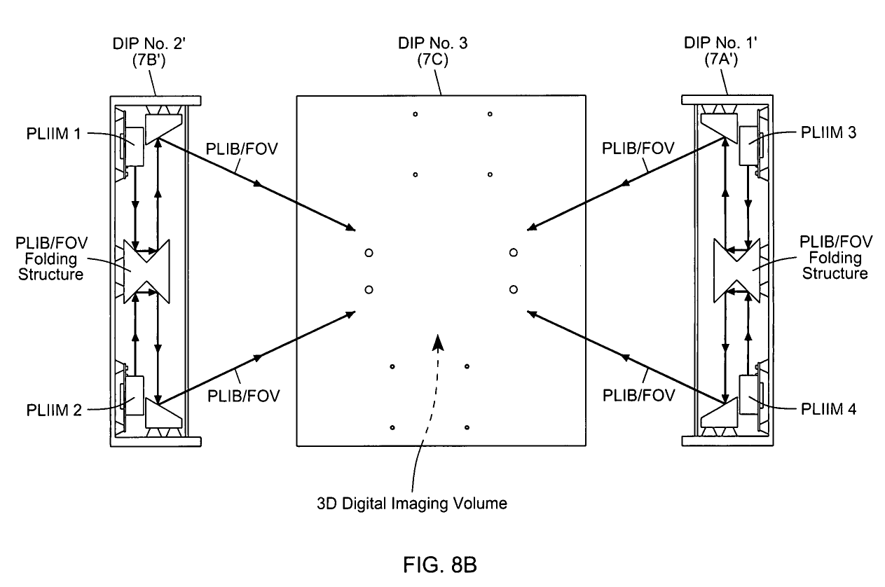

FIG. 8A shows a side-located PLIIM-based DIP employing a different alternative optical path layout using a PLIB-FOV folding mirror structure within the DIP housing to fold and direct the PLIB/FOVs as shown. FIG. 8B shows an alternative embodiment of the tunnel-type digital imaging system of the present invention employing the side-located PLIIM-based DIPs illustrated in FIG. 8A. There are many alternative ways of realizing each PLIIM-based DIP of the present invention.

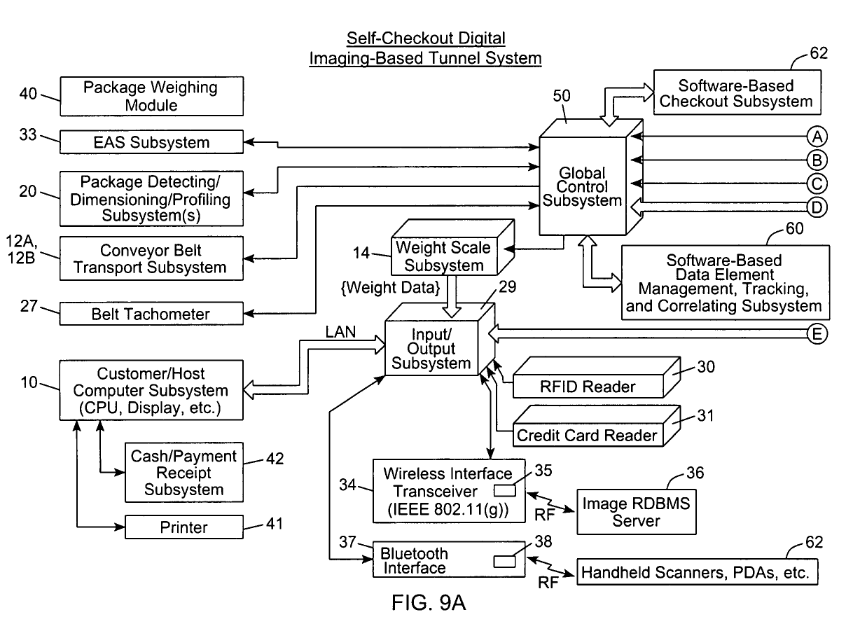

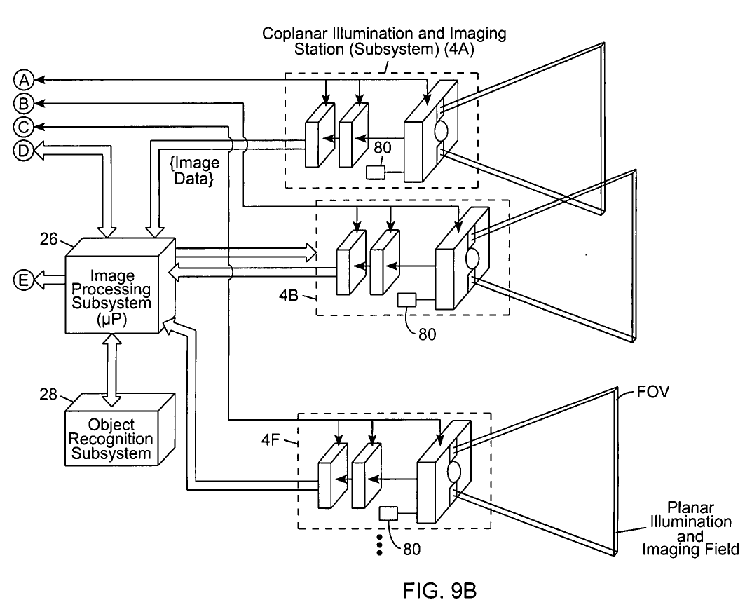

As shown in FIGS. 9A and 9B, the system architecture of tunnel-type digital imaging system of FIG. 1A is shown comprising: the complex of coplanar illuminating and linear imaging subsystems (PLIIMs) 4A through 4F, constructed using LED or VLD based linear illumination arrays and image sensing arrays, as described hereinabove in Applicants' WIPO Publication No. 2008/011067, incorporated herein by reference, and supported within the PLIIM-based DIPs of the tunnel system; a multi-channel multi-processor digital image processing subsystem 26 for supporting automatic image processing based bar code reading operations on digital linear image data streams generated by each coplanar illumination and imaging plane (PLIB/FOV) within the system; package detection/dimensioning/profiling subsystems 20 supported in the upper DIP; first and second conveyor-belt subsystems 12A and 12B; a conveyor-belt tachometer 27 for measurement conveyor belt speed in real-time; a software-based object recognition subsystem 28, for use in cooperation with the digital image processing subsystem 26, and automatically recognizing objects (such as vegetables and fruit) at the retail POS while being imaged by the system; electronic in-motion/under-conveyor weight scale 14 employing a matrix array of miniature piezoelectric load cell transducers 14C, positioned beneath the conveyor belt within and/or outside the tunnel system, for rapidly measuring the spatial-pressure distributions (i.e. weight) of objects positioned on the conveyor belt subsystem, and generating electronic data representative of measured weight of the object; an input/output subsystem 29 for interfacing with the image processing subsystem 26, the electronic in-motion/under-conveyor weight scale 14, an RFID reader 30, a credit-card reader 31 and Electronic Article Surveillance (EAS) Subsystem 32, including EAS tag deactivation block integrated in system housing and operable when packages are transported through the exit port of the tunnel system; a wide-area wireless interface (WIFI) 34 including RF transceiver and antenna 35 for connecting to the TCP/IP layer of the Internet as well as one or more image storing and processing RDBMS servers 36 (which can receive images lifted by system for remote processing by the image storing and processing servers 36); a BlueTooth® RF 2-way communication interface 37 including RF transceivers and antennas 38 for connecting to Blue-tooth® enabled hand-held scanners, imagers, PDAs, portable computers 62 and the like, for control, management, application and diagnostic purposes; a customer/host computer system 10 interfaced with the I/O/subsystem 29, and having an LCD visual display, a keyboard, a CPU and memory architecture, and a printer 41; a cash-coin handling subsystem 42; and a global control subsystem 50 for controlling (i.e. orchestrating and managing) the operation of the coplanar illumination and imaging subsystems (i.e. subsystems), electronic weighing subsystem 14, package weighing subsystem 40, software-based data element management, tracking and correlating subsystem 60, software-based checkout subsystem 62, and all other subsystems within the self-checkout system. As shown, each coplanar illumination and imaging subsystem 4A through 4F transmits frames of image data to the image processing subsystem 26, for image processing.

As shown in FIG. 10, each PLIIM-based coplanar illumination and imaging subsystem 4A through 4F employed in the tunnel-type digital imaging system of FIG. 1A comprises: an illumination subsystem 70 including a pair of linear array of VLDs or LEDs 71A, 71B (with or without spectral mixing as taught in Applicants' WIPO Publication No. 2008/011067, incorporated by reference, and associated focusing and cylindrical beam shaping optics 72A, 72B (i.e. planar illumination arrays or PLIAs), for generating a planar illumination beam (PLIB) 73A, 73B from the subsystem; a linear image formation and detection (IFD) subsystem 74 having a camera controller interface (e.g. FPGA) for interfacing with the local control subsystem (i.e. microcontroller) 75 and a high-resolution segmented, linear image sensing array 76 with far and hear FOV forming optics 77A and 77B providing far and near field of views (FOVs) 78A, 78B on the segmented image sensing array 76, as illustrated in FIG. 11E, that is coplanar with the PLIBs produced by the linear illumination arrays 71A, 71B, so as to form and detect linear digital images of objects within the near and far FOVs of the system; a local control subsystem 75 for locally controlling the operation of subcomponents within the subsystem, in response to control signals generated by global control subsystem 50 maintained at the system level, shown in FIG. 1B; an image capturing and buffering subsystem 79 for capturing linear digital images with the linear image sensing array 76 and buffering these linear images in buffer memory so as to form 2D digital images for transfer to image-processing subsystem 26 maintained at the system level, and subsequent image processing according to bar code symbol decoding algorithms, OCR algorithms, and/or object recognition processes; an (optional) high-speed image capturing and processing based motion/velocity sensing subsystem for producing motion and velocity data for supply to the local control subsystem 75 for processing and automatic generation of control data that is used to control the illumination and exposure parameters of the linear image formation and detection system within the subsystem. Details regarding the design and construction of planar illumination and imaging module (PLIIMs) can be found in Applicants' U.S. Pat. No. 7,028,899 B2 incorporated herein by reference.

When using coherent illumination sources such as VLDs to implement a linear array of VLDs, then despeckling techniques as taught in WIPO Publication No. 2002/43195 A2 and WIPO Publication No. 2008/011067, both incorporated herein by reference, can be practiced to reduce the spatial and/or temporal coherence of such illumination sources.

Also, the high-speed motion/velocity detection subsystem 80 can be realized employing any of the motion/velocity detection techniques detailed hereinabove so as to provide real-time motion and velocity data to the local control subsystem 75 for processing and automatic generation of control data that is used to control the illumination and exposure parameters of the linear image formation and detection system within the subsystem. Alternatively, motion/velocity detection subsystem 80 can be deployed outside of the illumination and imaging subsystem, as positioned globally.

During tunnel system operation, the local control subsystem (i.e. microcontroller) 75 receives object velocity data from either a conveyor belt tachometer 27 or other data source, and generates control data for optimally controlling the planar illumination arrays 71A, 71B and/or the clock frequency in the linear image sensing array 76 within the coplanar image formation and detection subsystem.

Referring to FIGS. 11A through 14, there is shown an illustrative embodiment of the dual field of view (dual-FOV) planar light illumination and imaging module (PLIIM) that can be used to implement the coplanar linear illumination and imaging subsystem schematically illustrated in FIG. 10.

As shown in FIGS. 11C and 11D, the dual-FOV PLIIM of FIGS. 11A and 11B comprises an assembly of components, namely: (i) an optics assembly support frame 82 supporting near and far FOV optical components 74A and 74D in precise spatial/optical alignment to each other, and mounting on a PC board 83 supporting segmented linear imaging/sensing array 76, and a pair of LED arrays 73A and 73B, disposed on opposite sides of the linear image sensing array 76, for producing a pair of illumination beams 73A and 73B; (ii) a folding mirror support panel 84 for supporting a dual-function folding mirror 85 and attaching to rear portion 86 of the optics assembly support frame 82 so as to (a) fold the FOVs of the near and far FOV forming optics 74A and 74B onto the first and second portions of the segmented linear image sensing array 76, as illustrated in FIG. 11E, as well as (b) fold the pair of illumination beams produced from illumination arrays 71A, 71B, through aperture stops 87A, 87B, along the optical axis of the FOV forming optics; and (iii) planar light illumination beam (PLIB) forming optics assembly 88 having an imaging window 89 and attaching to the optics assembly support frame 82, so as to shape the pair of folded illumination beams 90A and 90B into a pair of substantially planar illumination beam (PLIBs) 73A and 73B transmitted into the near and far FOVs 77A and 77B of the module in a coplanar manner. Optical depth of field (DOF) and sampling limit curves for the far field of view (FOV) forming optics are shown in FIG. 12A. Optical depth of field (DOF) and sampling limit curves for the near field of view (FOV) forming optics are shown in FIG. 12B. The depth of field (DOF) chart for the far field of view (FOV) forming optics employed in the dual-FOV PLIIM of the illustrative embodiment is shown in FIG. 12C. The depth of field (DOF) chart for the far field of view (FOV) forming optics employed in the dual-FOV PLIIM of the illustrative embodiment is shown in FIG. 12D.

As shown in FIGS. 13 and 14, the pair of PLIBs 77A and 77B are projected in a coplanar manner within the near and far field of views (FOVs) of the PLIIM-based subsystem, in accordance with the principles of the present invention.

As shown in the state diagram of FIG. 15, the first illustrative embodiment of the digital tunnel system of the present invention, runs a system control program, wherein all PLIIMs in each coplanar illumination and imaging subsystems 4A through 4F remains essentially in its Idle Mode (i.e. does not emit illumination) until the global system control subsystem 50 receives command data from the automatic package/object detection/profiling/dimensioning subsystem 14A integrated in the upper DIP 7C, indicating that at least one object or package has entered the tunnel structure of the tunnel system. Upon the detection of this “object in tunnel” condition, the global system control subsystem sends control signals to each and every PLIIM-based illumination and imaging subsystem to generate coplanar PLIB/FOVs.

FIG. 16 describes an exemplary embodiment of a computing and memory architecture platform that can be used to implement the tunnel-type digital imaging system of FIG. 1A. As shown, this hardware computing and memory platform can be realized on a single PC board, along with the electro-optics associated with the coplanar illumination and imaging subsystems and other subsystems generally described hereinabove. As shown, the hardware platform comprises: at least one, but preferably multiple high speed dual core microprocessors, to provide a multi-processor architecture having high bandwidth video-interfaces and video memory and processing support; an FPGA (e.g. Spartan 3) for managing the digital image streams supplied by the plurality of digital image capturing and buffering channels, each of which is driven by a PLIIM-based coplanar illumination and imaging subsystem (e.g. linear CCD or CMOS image sensing array, image formation optics, etc) in the system; a robust multi-tier memory architecture including DRAM, Flash Memory, SRAM and even a hard-drive persistence memory in some applications; analog and digital circuitry for driving arrays of VLDs and/or LEDs, employed in the PLIIM-based subsystems; interface board with microprocessors and connectors; power supply and distribution circuitry; as well as circuitry for implementing the others subsystems employed in the system.

FIG. 17 describes a three-tier software architecture that can run upon the computing and memory architecture platform of FIG. 16, so as to implement the functionalities of the tunnel-type digital imaging system of the present invention. Details regarding the foundations of this three-tier architecture can be found in Applicants' copending U.S. application Ser. No. 11/408,268, incorporated herein by reference. Preferably, the Main Task and Subordinate Task(s) that would be developed for the Application Layer would carry out the system and subsystem functionalities.

In an illustrative embodiment, the Main Task would carry out the basic object detection, management, tracking and correlation operations supported within the 3D imaging volume by each object detecting/profiling/dimensioning subsystem, and would be called and instantiated whenever one or more objects have been detected as entering the tunnel system by the object detecting/profiling/dimensioning subsystems supported in the upper DIP. The kinds of functions to be performed by the Main Task during the Active State are reflected in the package identification and dimension data element management, tracking, and correlation subsystem 60 schematically represented in FIG. 18. The Subordinate Task, on the other hand, would be called to carry out the package/object identification (i.e. bar code reading) operations along the information processing channels of those PLIIM-based subsystems configured in their Active State (Mode) of operation whenever one or more objects have been detected entering the tunnel system, and are determined to still be in the 3D imaging volume of the tunnel system. Preferably, along each information management channel of the tunnel system (corresponding to each PLIIM-based coplanar and illumination subsystem), the Subordinate Task will oversee the combining of linear digital images. Details concerning task development will readily occur to those skilled in the art having the benefit of the present invention disclosure.

In FIG. 18, there is shown a model of the software-based object detection, management, tracking and correlation subsystem 60, called and executed by the Main Task running on the computing and memory architecture platform of FIG. 16, and cooperating with the software-implemented checkout computer subsystem 62 interfaced with (i) the electronic (scanned) package module/subsystem 40 located on the output side of the tunnel system, and (ii) electronic and physical cash payment subsystems 42, and (iii) visual and hard copy display devices 40, 41. The software-based object detection, management, tracking and correlation subsystem 60 supports a number of functions in the tunnel system, namely: (i) the detection, management and tracking, in real-time, of product profile/dimension data elements generated by object detection/profiling/dimensioning subsystems employed in the tunnel-type system, as well as product identification data elements generated by each PLIIM-based coplanar illumination and imaging subsystem illustrated in FIGS. 10 and 11C; and (ii) the correlation of one product dimension data element with one product identification data element managed within the queues of the software-based object detection, management, tracking and correlation subsystem modeled in FIG. 18, as package-type objects are automatically transported through the tunnel system of the present invention during self and cashier-assisted check-out operations in retail store environments.

In FIG. 18, the inputs to software-based data element management, tracking, and correlation subsystem 60 include the following: (i) time-stamped product detection/dimension data elements {PDDE} generated by the automatic package profiling/dimensioning subsystem, for each package entering and exiting the retail tunnel system; (ii) space-stamped product weight data elements {PWDE} generated by the electronic in-motion package weighing subsystem/module, for each package being transported through the retail tunnel system; (iii) far/near PLIB/FOV-indexed product identification data elements {PIDE} generated by particular PLIB/FOVs supported in the retail tunnel system; (iv) geometrical models for the PLIB/FOVs {PLIB/FOV} supported in the retail tunnel system, referenced from a global coordinate reference system symbolically embedded in the retail tunnel system; and (v) the constant speed of the conveyor belt in the retail tunnel system {V_{belt}}. The computed outputs from the software-based data element management, tracking, and correlation subsystem 60 are: the combined data set {Product ID; Product Weight; Product Dimensions} for the complete list of products scanned through the retail tunnel system during a batch scanning operation.

In the illustrative embodiment, the software-based data element management, tracking, and correlation subsystem 60 can be constructed in a manner similar to the data element management, tracking, and correlation subsystem (3950) shown in FIGS. 51 and 51A, and specified in great detail in corresponding portions of the detailed description of Applicant's WIPO Publication No. WO/99/49411, incorporated herein by reference. The primary differences are described as follows. In the present invention, far/near PLIB/FOVs are used to capture linear images of scanned products in the tunnel system, rather than flying-spot laser beams generated by non-holographic and holographic laser scanning subsystems, disclosed in Applicants' WIPO Publication No. WO 99/49411. Also, instead of using geometrical models of laser scan beams, the subsystem 60 will employ geometrical models of each near/far PLIB/FOV supported in the 3D imaging volume of the tunnel system, allowing the subsystem to track where, in the tunnel system, any particular read code symbol on a product was located when its corresponding image was captured in the tunnel system. Also, spatial-pressure distributions (and thus computed weights) of products will correspond to time-stamped height profile maps captured by the package detection/profiling/dimensioning subsystem(s) 14.

Once the batch of products has been scanned through the retail tunnel system, the output from subsystem 60 (e.g. {Product ID, Dimensions, Weight}) is supplied to the software-based checkout subsystem 62 which has access to either a local or remote RDBMS storing retail price information about each UPC or UPC/EAN coded product, as well as information about each product's dimensions and weight. Also, the checkout subsystem 62 includes output displays such as a touchscreen LCD 40, hard copy printers 41, and electronic and cash payment systems 42.

In FIGS. 19A through 19C, there is set forth an illustrative embodiment of a method of checking out a batch of products to be purchased by a consumer using the self-checkout retail tunnel system of the present invention. As shown, this method involves the software-based object detection, management, tracking and correlation subsystem 60, checkout subsystem 62, electronic package weighing subsystem 40, payment subsystems 42 and the output displays 40, 41 schematically illustrated in FIG. 18 and other figures appended hereto.

As indicated at Block A in FIG. 19A, during self check-out of a batch of consumer products to be purchased, the batch of the products are first placed on the conveyor belt of the retail digital imaging-based tunnel system.

Then, as indicated at Block B, the automatic package detecting/profiling/dimensioning subsystem at the input port automatically detects, profiles and dimensions each product as it enters the input port of the retail tunnel system, the data element management, tracking and correlation subsystem 60 generates a time-stamped package detection/dimension data element for each detected product, and then buffers the data element in the data element queues of the data element management, tracking and correlating subsystem.

As indicated at Block B, the in-motion package weighing subsystem 14 automatically detects the spatial-pressure distribution of each product as it is being transported through the retail tunnel system along the conveyor belt, computes its equivalent weight value, and the data element management, tracking and correlation subsystem 60 generates a space-stamped product weight data element for each weighed product, and buffers the data element in data element queues of the data element management, tracking and correlating subsystem.

As indicated at Block D in FIG. 19B, one or more of the PLIIM-based coplanar illumination and imaging subsystems 4A-4F automatically identifies each product transported through the retail tunnel system (e.g. by capturing a digital image of a code symbol located on the product using one or more of the PLIB/FOVs, and the digital image processor 26 reads this code symbol to identify the product), generates an PLIB/FOV-indexed product identification data element for each identified product, and the data element management, tracking and correlation subsystem 60 buffers the data element in the data queues of the data element management, tracking and correlating subsystem.

As indicated at Block E, the automatic package detecting/profiling/dimensioning subsystem 14 at the exit port automatically detects (and optionally, profiles and dimensions again), and the data element management, tracking and correlation subsystem 60 generates a time-stamped product detection/dimension data element for each redetected product, and the data element management, tracking and correlation subsystem buffers the data element in data queues of the data element management, tracking and correlating subsystem.

As indicated at Block E, the data element management, tracking and correlating subsystem 60 automatically analyzes and processes the data elements buffered in its data element queues, so as to correlate each identified product with its corresponding dimensions and weight, and generates a combined {product ID/dimensions/weight} data set for each product being scanned through the retail tunnel system.

As indicated at Block G, the checkout subsystem 62 automatically compiles and displays the list of products scanned through the retail tunnel system, accesses a retail product price information in a local or remote RDBMS, and computes a total bill for the products to be purchased, including itemized prices for the batch of products being checked out.

As indicated at Block H of FIG. 19C, the output display subsystem 40, 41 displays instructions for the consumer to pack the scanned products in shopping bag(s), cart(s) or other container(s), whereupon, the electronic package weighing subsystem 40 automatically weighs these packed products and provides such measurements to the checkout subsystem 62, which then automatically compares the measured weight of the packed products against the total measured weight of the batch of scanned products, measured by the retail tunnel system.

As indicated at Block I, in the event that the total weight of products/goods measured at Block H does correspond with total weight of products measured by the retail tunnel system, then the consumer is provided the opportunity to make payment for the bills of products being checked-out, and upon making payment, the checkout subsystem 62 generates a sales receipt as proof of full payment for the purchased bill of goods/products.

As indicated at Block J, in the event that the total weight of products/goods measured at Block H does correspond with total weight of products measured by the retail tunnel system, then the checkout subsystem 62 automatically generates an alarm or signal advising a retail store supervisor about such weight discrepancies.

As indicated at Block K, the retail store supervisor takes appropriate measures to rectify discrepancies in the measured weights of the batch of products during tunnel scanning and package weighing operations.

The above described method of tunnel system operation is just one illustrative embodiment of how it can be programmed to operate to carry out diverse kinds of business objectives in demanding retail store environments.

In another mode of operation, the tunnel system can be used to transport batches of produce items through the tunnel system, and automatically recognize the type of produce being transported, weigh the produce batch, and compute the retail price thereof based on the current retail price list for produce items in the retail store.

In yet another illustrative embodiment, the tunnel system of the present invention can be provided with an external video camera trained on the customer during self-checkout operations, to capture video streams which can be watched remotely by retail store supervisors, security guards and the like.

### Retail Digital Imaging Based Tunnel System Capable of Five-Sided Omni-Directional Imaging of Objects Transported Through Tunnel System

FIG. 20A shows a second illustrative embodiment of the tunnel-type digital imaging system 1′, installed about a split-type conveyor belt countertop surface provided at a self-checkout, or cashier-assisted station in a retail store environment. The primary difference between this tunnel system 1′ and the tunnel system 1 shown in FIG. 1A through 19, is that the tunnel system of FIG. 20A does not have a conveyor-belt gap region 13, through which a coplanar PLIB/FOV is projected to read bar code symbols and the like on the underside of packages being transported through the retail tunnel system. Consequently, the tunnel system of FIG. 20A is capable of omni-directional reading of bar code symbols on only five sides of packages transported on its conveyor belt, arranged in either a singulated or non-singulated manner, but is not capable of reading code symbols on the bottom, conveyor-belt facing side of products transported along the conveyor belt. In all other respects, the first and second illustrative embodiments of the retail tunnel systems of the present invention are substantially the same.

### Retail Digital Imaging Based Tunnel Systems Having Open Housing Architectures and Employing Intelligent Illumination Control

In the first and second illustrative embodiments of the tunnel system of the present invention, the tunnel housing was shown to be of a substantially closed architecture, made from light opaque materials shielding internal illumination from being transmitted to the eyes of human cashiers and customers during checkout operations. Consequently, the tunnel housing generally appears like a shell or tunnel like structure having an input and an output port, with a conveyor belt structure passing therebetween. However, in such retail environments, it might be desired for the tunnel housing structure to be minimized and making it appear more “open”, yet supporting its basic components (e.g. PLIIM-based package identification subsystems, package weighing subsystems, and package detection/profiling/dimensioning subsystems) in arrangements that achieve automated package identification, dimensioning, weighing, tracking and correlation functions, in accordance with the principles of the present invention.

In such open-type tunnel housing architectures, without illumination shielding provided by the tunnel housing/enclosure, there is typically the need to either intelligently control illumination within the tunnel system, and/or use a combination of visible and invisible (i.e. IR) spectral illumination during tunnel operations. Various techniques for intelligently controlling illumination and spectral mixing are disclosed in great detail in Applicants' WIPO Publication No. WO 2008/011067, incorporated herein by reference. Also, techniques can be practiced to intelligently control the ratio of visible and invisible VLD and/or LED sources of illumination so as to maximize that projected illumination falls incident on the surface of the object, and thus minimize the illumination of customers at the POS.

When using coherent illumination sources such as VLDs, then despeckling techniques as taught in WIPO Publication Nos. WO 2002/43195 and WO 2008/011067, incorporated herein by reference, can be practiced to reduce the spatial and/or temporal coherence of such illumination sources.

Techniques can be practiced to employ coplanar and/or coextensive illuminating and imaging subsystems, constructed using (i) VLD-based and/or LED-based illumination arrays and linear and/area type image sensing arrays, and (ii) real-time object motion/velocity detection technology embedded within the system architecture so as to enable: (1) intelligent automatic illumination control within the 3D imaging volume of the system; and (2) automatic image formation and capture along each coplanar illumination and imaging plane therewithin. Also, advanced automatic image processing operations can be practiced to support diverse kinds of value-added information-based services delivered in diverse end-user environments, including retail POS environments as well as industrial environments.

Modifications that Come to Mind

In the illustrative embodiments described above, the multi-channel digital image processing subsystem 26 has been provided as a centralized processing system servicing the image processing needs of each dual-FOV PLIIM-based illumination and imaging subsystem in the system. It is understood, however, that in alternative embodiments, each subsystem 4A through 4F can be provided with its own local image processing subsystem for servicing its local image processing needs.

The tunnel-type digital imaging-based system can also be provide with one or more coextensive area-type illumination and imaging subsystems, each generating an area-type illumination beam and field of view (FOV), which forms a coextensive illumination and imaging zone that is projected through and intersects above conveyor belt structure, within the 3D imaging volume for even more aggressive digital imaging of objects passed therethrough.

Also, the tunnel-type digital-imaging systems of the present invention, disclosed herein, provide full support for (i) dynamically and adaptively controlling system control parameters in the digital image capture and processing system, as disclosed and taught in Applicants' PCT Application Serial No. PCT/US2007/009763, as well as (ii) permitting modification and/or extension of system features and function, as disclosed and taught in PCT Application No. WO 2007/075519, supra.

Several modifications to the illustrative embodiments have been described above. It is understood, however, that various other modifications to the illustrative embodiment of the present invention will readily occur to persons with ordinary skill in the art. All such modifications and variations are deemed to be within the scope and spirit of the present invention as defined by the accompanying Claims to Invention.

1-84. (canceled)

85. A tunnel-type digital imaging-based system for use in automated self-checkout and cashier-assisted checkout operations in retail store environments, said tunnel-type digital imaging-based system comprising:
a conveyor belt structure installed at a retail POS station;
a tunnel housing arrangement having an input port and an output port, and supported over said conveyor belt structure so that said conveyor structure transports objects from said input port to said output port, through said tunnel housing arrangement, during tunnel scanning operations;
a plurality of illumination and imaging subsystems mounted within said tunnel housing arrangement, and generating a plurality of illumination beams and field of views that are projected and intersect to generate a complex of illumination and imaging regions within a 3D imaging volume above said conveyor belt structure within said tunnel housing arrangement, for omni-directional imaging of objects passed therethrough during tunnel scanning operations so as to capture linear digital images of said objects; and
a digital image processor for processing said digital images so as to read code symbols on said objects, and identify each said object being transported through said tunnel housing arrangement.

86. The tunnel-type digital imaging-based system of claim 85, wherein each said illumination and imaging subsystem comprises a linear digital imaging engine, having independent near and far field of view (FOV) light collection optics focused onto separate segmented regions of a linear image sensing array, so as to improve the depth of field of each coplanar illumination and imaging subsystem, within said tunnel housing arrangement.

87. The tunnel-type digital imaging-based system of claim 85, which further comprises an automatic object detecting/profiling/dimensioning subsystem mounted integrated with said tunnel housing arrangement, for automatically detecting, profiling and dimensioning objects as the transported through said tunnel housing arrangement.

88. The tunnel-type digital imaging-based system of claim 85, which further comprises a checkout computer subsystem having components selected from the group consisting of a magnet-stripe or RF-ID card reader, visual display, keyboard, printer, and cash/coin handling subsystem.

89. The tunnel-type digital imaging-based system of claim 87, which further comprises an automatic object an electronic in-motion object weighing subsystem installed beneath the conveyor belt structure for automatically detecting the spatial-pressure patterns associated with objects being transported through said tunnel housing arrangement on said conveyor belt structure, and converting said spatial pressure patterns to object weight measures.

90. The tunnel-type digital imaging-based system of claim 89, which further comprises a data element management, tracking and correlation subsystem for managing, tracking and correlating object dimension data elements and object weight data elements with each object identification data element generated within said tunnel-type digital imaging-based system.

91. The tunnel-type digital imaging-based system of claim 89, which further comprises: an electronic package weighing subsystem installed on the output port of said tunnel housing arrangement, for weighing the weight of objects after they have been scanned through said tunnel housing arrangement; and a checkout computer subsystem for comparing the total weight of a group of objects transported through said tunnel housing arrangement, against the total weight of a group of scanned object being packed prior to purchase, and generating indications of whether or not weight discrepancies exist at the time of checkout.

92. The tunnel-type digital imaging-based system of claim 85, wherein said plurality of illumination beams are generated by an array of coherent or incoherent light sources.

93. The tunnel-type digital imaging-based system of claim 92, wherein said array of coherent light sources comprises an array of visible laser diodes (VLDs).

94. The tunnel-type digital imaging-based system of claim 92, wherein said array of incoherent light sources comprises an array of light emitting diodes (LEDs).

95. The tunnel-type digital imaging-based system of claim 85, wherein said digital image processor is capable of reading (i) code symbols having bar code elements that are oriented substantially horizontal with respect to said conveyor structure, as well as (ii) code symbols having bar code elements that are oriented substantially vertical with respect to said conveyor structure.

96. The tunnel-type digital imaging-based system of claim 85, wherein each illumination and imaging subsystem comprises: a planar light illumination module (PLIM) that generates a planar light illumination beam (PLIB); and a linear image sensing array provided with field of view (FOV) forming optics for generating a FOV which is coplanar with its respective PLIB.

97. The tunnel-type digital imaging-based system of claim 85, wherein are arranged within said tunnel housing arrangement, so that said plurality of illumination and imaging regions generate at least a pair of bi-directional viewing regions within said 3D imaging volume.

98. The tunnel-type digital imaging-based system of claim 85, wherein said conveyor structures comprises a first conveyor belt structure portion and a second belt conveyor structure portion, each being arranged in substantially a common plane, with a narrow gap region being formed between said first conveyor belt structure portion and said second conveyor belt structure portion, within the spatial confined of said tunnel housing arrangement, and wherein at least one said plurality of illumination and imaging subsystems is mounted beneath said conveyor belt structure so that at least one illumination and imaging regions projects through said narrow gap region for imaging the underside of objects as said objects are transported through said tunnel housing arrangement.

99. The tunnel-type digital imaging-based system of claim 85, wherein each said illumination and imaging subsystem includes a linear imaging module realized as an array of electronic image detection cells which is segmented into a first region onto which a near field of view (FOV) is focused by way of a near-type FOV optics, and a second region onto which a far field of view (FOV) is focused by way of a far-type FOV optics, to extend the field of view and depth of field of each such illumination and imaging subsystem.

100. The tunnel-type digital imaging-based system of claim 85, which further comprises an integrated RFID tag deactivation device installed within or proximate to said tunnel housing arrangement, and an integrated EAS antenna installed within said tunnel housing arrangement, for automatically deactivating RFID tags on objects are they are transported through said tunnel housing arrangement.

101. The tunnel-type digital imaging-based system of claim 85, which further comprises a conveyor belt tachometer to measure the speed of the conveyor structure and objects transported on said conveyor belt structure.

102. The tunnel-type digital imaging-based system of claim 85, which further comprises an imaging-based motion sensor for use in measuring the speed of objects moving through said tunnel housing arrangement.

103. The tunnel-type digital imaging-based system of claim 85, wherein each said illumination and imaging subsystems includes a linear imaging module realized as an array of electronic image detection cells having programmable integration time settings, responsive to the automatically detected speed of said objects being transported along said conveyor belt structure, for enabling high-speed image capture operations.

104. The tunnel-type digital imaging-based system of claim 85, wherein each said illumination and imaging subsystem comprises: a pair of planar illumination arrays mounted about an image formation and detection module providing said field of view, so as to produce a substantially planar illumination beam (PLIB) which is coplanar with said FOV during object illumination and imaging operations, and one or more folding mirrors are used to direct the resulting coplanar illumination and imaging plane (PLIB/FOV) into said 3D imaging volume.

105. The tunnel-type digital imaging-based system of claim 104, wherein each said illumination and imaging subsystem supports an independent image generation and processing channel that receives frames of linear (1D) images from one said linear image sensing array and automatically buffers these linear images in video memory and automatically assembles these linear images to construct 2D images of the object taken along the field of view of the coplanar illumination and imaging plane associated with the subsystem, and then processes these images using exposure quality analysis algorithms, bar code decoding algorithms, and the like.
